(19) United States
(12) Patent Application Publication
(10) Pub. No.: US 2026/0330152 A1
(43) Pub. Date: Oct. 22, 2026

(54) SYSTEM

(71) Applicant: SoftBank Group Corp., Tokyo (JP)

(72) Inventor: Yoshitake MIYAZAKI, Tokyo (JP)

(73) Assignee: SoftBank Group Corp., Tokyo (JP)

(21) Appl. No.: 19/650,371

(22) Filed: Apr. 17, 2026

(30) Foreign Application Priority Data
Apr. 22, 2025 (JP) 2025-070209

(51) Int. Cl. G06F 40/40; G06F 16/432; G06F 16/45; G06F 40/284; G06F 40/30; G06V 30/19; G10L 21/0208

(52) U.S. Cl. CPC G06F 40/40; G06F 16/433; G06F 16/45; G06F 40/284; G06F 40/30; G06V 30/19; G10L 21/0208

(57) ABSTRACT

The present invention relates to a system for automating internal consultation responses regarding information security, and has a configuration in which a consultation reception unit receives a consultation content from a user, an information reference unit searches for related information from internal regulations, guidelines, and a past case database, and a generative AI processing unit automatically generates an optimal response text and additional questions based on these and presents them to the user. The generative AI is responsible for context understanding of the consultation content, summarization and integration of the related information, generation of additional questions for an ambiguous consultation, prioritization of a plurality of pieces of information, and the like, and is characterized in that a workload of consultation responders is reduced, and a consulter can quickly and accurately obtain a final response.

### CROSS-REFERENCE TO RELATED APPLICATION

The present application claims priority to and incorporates by reference the entire contents of Japanese Patent Application No. 2025-070209 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is that security consulters, including information security managers, consultation responders in each department, and all employees, face the problem that it is difficult to quickly and accurately find necessary information from among numerous information security-related guidelines and internal regulations scattered within the company, and even if they reach the guidelines, it is difficult to determine which department or person in charge to consult; furthermore, there is a problem of an increase in the workload of consultation responders in each department due to the occurrence of many consultation cases, and a problem that interactions between the consulter and the responder become complicated until necessary information is gathered, requiring a great deal of time and effort to obtain a final response; in addition, there is a problem that the contents of the guidelines are difficult to understand, so the consulter cannot fully understand the contents, making appropriate consultation or self-resolution difficult; and because these problems exist in a complex manner, the efficiency and response quality of internal consultations regarding information security decrease, which hinders the maintenance and improvement of overall operational efficiency and security levels. Therefore, an object of the present invention is to consistently realize processes from consultation reception to searching for guidelines and past cases, automatic generation of an optimal response, and automatic request for additional information by an automated system utilizing generative AI, thereby enabling the consulter to quickly and accurately obtain a final response, significantly reducing the workload of consultation responders, and improving the efficiency and quality of information security consultation operations throughout the company.

### SUMMARY OF THE INVENTION

As a means for solving the problem, a system for automating consultation responses regarding information security is constructed, and the system comprises: a consultation reception unit configured to receive a security consultation content input from an internal user; an information reference unit configured to hold internal regulations, security-related guidelines, and a past consultation case database in a storage device, and search for corresponding guidelines and past cases based on keywords and context information included in the consultation content received from the consultation reception unit; and a generative AI processing unit configured to perform natural language processing using the consultation content and the searched guidelines and past cases as inputs, generate an optimal response text to the consultation content, and present the response text to the user via the consultation reception unit, and the system is further configured to automatically determine ambiguity or missing information in the consultation content using generative AI, and generate a guidance text prompting input of additional information as necessary, thereby providing a means to enable a consulter to quickly and accurately obtain a final response, significantly reduce a workload of consultation responders, and realize improvement in efficiency and quality of information security consultation operations throughout the company.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

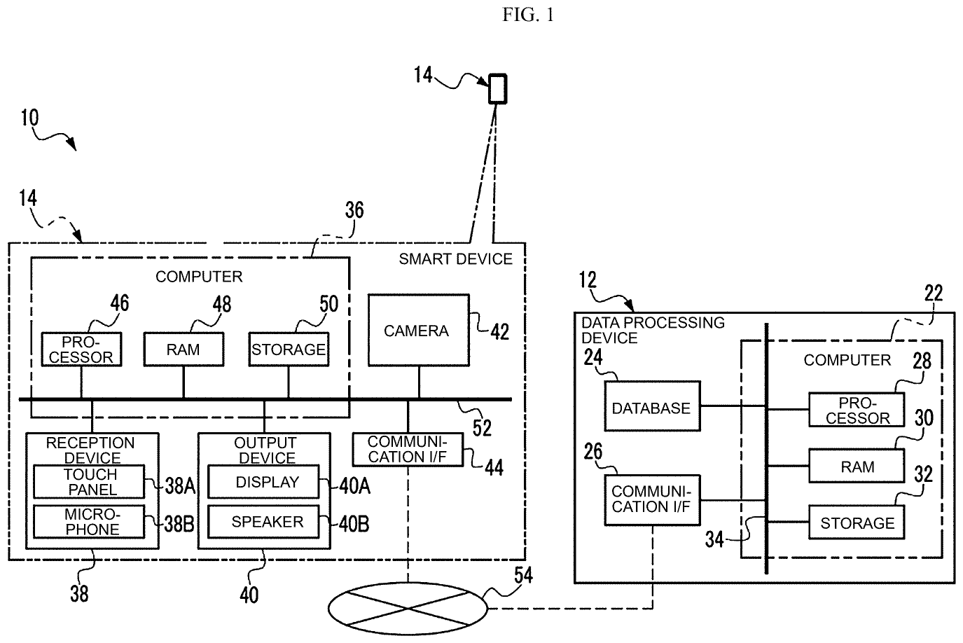

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

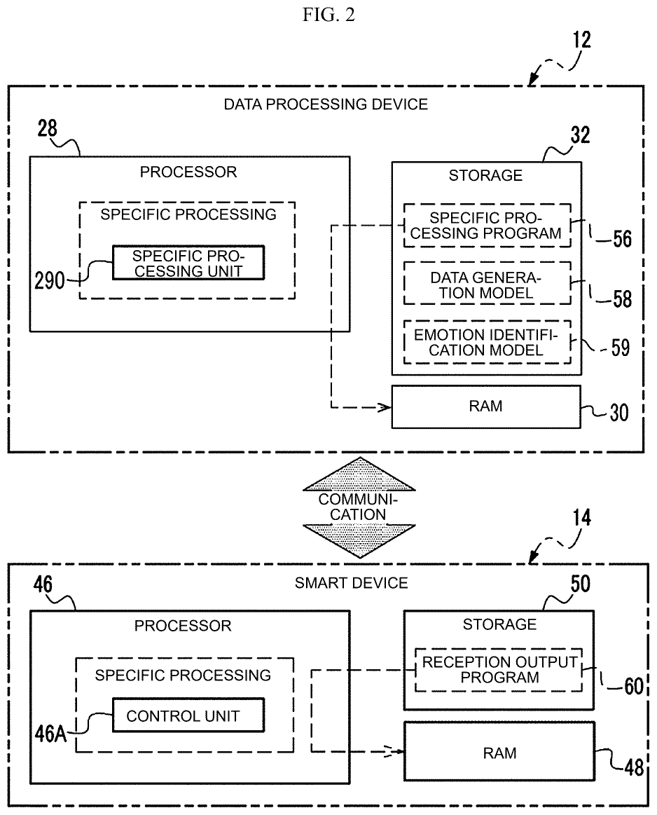

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

An embodiment of the present invention is a system for automating internal consultation responses regarding information security, and is composed of a server and a terminal. The terminal is an information processing apparatus such as a personal computer, a smartphone, or a tablet operated by a user, and the server has main functions such as a consultation reception unit, an information reference unit, a generative AI processing unit, a log management unit, and an administrator interface unit. The terminal provides a user interface for the user to input a consultation content regarding security, and plays a role of transmitting the input consultation content to the server. For example, a text box saying “Please input consultation content”, a “Send” button, a link for referring to a past consultation history, a shortcut to an FAQ, and the like are displayed on a screen of the terminal. Specifically, the system adopts a distributed computing architecture. The system establishes a secure communication session between a client terminal and a backend server. The terminal acquires an input natural language text as a character code string. The terminal serializes the character code string into a payload in a JSON format. The terminal transmits the payload to the server via an HTTPS protocol. The server receives asynchronous requests from a plurality of terminals in parallel by multi-thread processing. The server deserializes the received payload and expands it into a data structure on a memory. The system digitizes a reception process of an information security consultation by such a cooperative operation of hardware and software. The system enables an immediate response 24 hours a day, 365 days a year without human operators. Thereby, the system dramatically improves a processing speed of consultation reception. The system implements the generative AI processing unit having a large language model as a core in the server. The generative AI processing unit includes a multi-layer neural network based on a transformer architecture. The system tokenizes an input text and maps it to a high-dimensional vector space. The system calculates a dependency relationship between tokens using a self-attention mechanism. The system thereby mathematically analyzes a context. The system processes a natural language by an unconventional method different from conventional keyword matching. The system performs fine-tuning specialized for a specific domain of information security in advance. The system optimizes weight parameters of a model using a cross-entropy error function. The system thereby improves inference accuracy for domain-specific technical terms. As a specific application field of the system, a help desk operation of an information system department in a large enterprise can be cited. The system automatically processes a huge amount of security inquiries from employees. The system dramatically reduces a business load on a management department.

On the server side, first, the consultation reception unit receives the consultation content received from the terminal, and records this together with metadata such as a time, a user ID, terminal information, and a consultation category (AI use, data taking-out, password management, etc.). For example, when the user inputs “I want to use generative AI for business, but what kind of procedure is necessary?”, the consultation reception unit receives this content, automatically issues a consultation ID, and stores the consultation content, the time, and user information in a database. At the time of receiving the consultation content, when there is a defect or a typographical error in the input content, a correction candidate is automatically presented, or when category classification is ambiguous, the generative AI automatically performs category estimation. Specifically, the consultation reception unit executes a natural language processing pipeline on the received text data. The consultation reception unit divides the input text into word units using a morphological analyzer. The consultation reception unit assigns part-of-speech information of each word. The consultation reception unit applies a spell check algorithm to detect a typographical error based on an edit distance. When a typographical error is detected, the consultation reception unit generates a correction candidate vector by collating with a dictionary database. The consultation reception unit executes a category estimation process using the generative AI. The generative AI receives a word embedding vector of the preprocessed text as input data. The input data is, for example, a 512-dimensional floating-point number array. As a specific example of the input data, a vector group corresponding to tokens such as “generative AI”, “business use”, and “procedure” can be cited. The generative AI inputs these input vectors to a multi-layer perceptron. The generative AI applies a softmax function to output a probability distribution belonging to each category. The output data is an array of probability scores such as “AI use: 0.85”, “data taking-out: 0.10”, and “password management: 0.05”, for example. The consultation reception unit uses this output result in a subsequent process. The consultation reception unit determines whether or not a maximum probability score exceeds a preset threshold value (for example, 0.7). When the threshold value is exceeded, the consultation reception unit assigns the category to the metadata as a confirmed category. When the threshold value is not reached, the consultation reception unit routes it to an exception handling module as “unclassifiable”. The system thus uses probabilistic inference in a high-dimensional space. The system replaces a conventional classification work relying on human intuition with a mathematical algorithm. The system thereby significantly improves accuracy and processing speed of category classification. The system generates a unique hash value as a consultation ID at the time of writing to the database. The system cryptographically guarantees data integrity. As a specific application field of the system, an automatic triage system for incident reports in a compliance department can be cited. The system instantly identifies a consultation with a high degree of urgency and preferentially processes it.

Next, the information reference unit searches for information related to the consultation content from internal regulations, security-related guidelines, guidelines regarding AI use, data taking-out regulations, password management regulations, outsourcing regulations, cloud use regulations, a past consultation case database, and the like stored in the storage device in the server. For example, keywords such as “generative AI”, “business use”, and “procedure” are extracted, and guidelines and past consultation cases corresponding to these are searched at high speed. For a search algorithm, not only simple keyword matching but also semantic similarity determination using a natural language processing technology by the generative AI is utilized. For example, semantic analysis by the generative AI is utilized so as to be able to respond to consultation contents with different expressions such as “I want to use AI”, “application method for AI use”, and “points to note when introducing AI”. Furthermore, the information reference unit also considers a revision history, an expiration date, and an application range (company-wide application, specific department limitation, etc.) of a guideline, and extracts only the latest and appropriate information. Specifically, the information reference unit implements a semantic search engine using a vector database. The information reference unit divides all documents in the storage device into chunks in advance. The information reference unit inputs each chunk to an embedding model to generate a high-dimensional document vector. The information reference unit indexes these document vectors and stores them in the vector database. Upon receiving the consultation content of the user, the information reference unit generates a query vector using the same embedding model. The information reference unit calculates a cosine similarity between the query vector and a document vector group. By this similarity calculation, the information reference unit mathematically specifies a document having a close meaning even if a literal surface is different. The system overcomes a limitation of a keyword search based on a conventional inverted index. The system adopts an unconventional method of distance calculation in a high-dimensional vector space. The system thereby dramatically improves a recall rate and a precision rate of a search. The information reference unit executes a filtering process on a search result. The information reference unit evaluates a time stamp and an expiration date flag assigned to each document. The information reference unit compares with a current time and excludes an invalid document from a result set. The information reference unit collates an affiliated department ID of the user and application range metadata of the document by a logical product operation. The information reference unit reliably blocks unauthorized information. The information reference unit executes these processes using a high-speed data structure on a memory. The information reference unit avoids a bottleneck of disk I/O and minimizes a search latency. As a specific application field of the system, a contract review support system in a legal department can be cited. The system instantly presents a past similar contract and related laws and regulations. The system significantly streamlines a research work of an expert.

The generative AI processing unit receives the guidelines and past cases extracted by the information reference unit and the consultation content of the user as inputs, and generates an optimal response text using a natural language processing model. For example, a specific response based on contents of the guidelines and past cases, such as “Application to an information security department is necessary for business use of generative AI, and an examination is performed after submission of an application form”, is automatically generated. The generative AI summarizes the contents of the extracted guidelines and cases, and converts them into appropriate expressions in accordance with the consultation content. For example, a citation of an article such as “Based on Article 3 of the AI Use Guidelines, prior application is mandatory at the time of business use” and a specific case introduction such as “There was a similar consultation in the past, and an entry example of an application form is as follows” are also automatically performed. Specifically, the generative AI processing unit adopts a retrieval-augmented generation architecture. The generative AI processing unit uses a large language model as an inference engine. The generative AI processing unit receives, as input data, a prompt tensor in which a consultation content text of the user and a text chunk group of related documents acquired from the information reference unit are combined. The number of dimensions of the input data is, for example, a maximum of 8192 tokens. As a specific example of the input data, a structured text string such as “Consultation content: I want to use AI. Reference information 1: Guideline Article 3 . . . Reference information 2: Past case . . . ” can be cited. The generative AI processing unit inputs this prompt tensor to an encoder and a decoder of a transformer model. The generative AI processing unit executes an autoregressive decoding process. The generative AI processing unit calculates an appearance probability distribution of a next token. The generative AI processing unit selects an optimal token string from this probability distribution using a beam search algorithm. The generative AI processing unit outputs a character string of the generated response text and a certainty score of each generated token as output data. As a specific example of the output data, a text “Prior application is necessary” and numerical data of an average certainty of 0.92 can be cited. The generative AI processing unit passes this output result to a subsequent processing module. When the certainty score falls below a specified threshold value, the subsequent processing module determines that a risk of hallucination is high. In that case, the subsequent processing module automatically adds a disclaimer “Please contact the security department directly for details” to the end of the response. The system thus combines a probabilistic language generation model and a deterministic rule-based process. The system thereby guarantees accuracy and safety of the generated response. The system does not imitate a human thought process, but executes a computer-specific process of statistical inference based on a large-scale corpus. As a specific application field of the system, an automatic response chatbot in customer support can be cited. The system dynamically refers to a product manual and a past response history to generate a highly accurate response.

Furthermore, when the consultation content has ambiguity or missing information, the generative AI automatically determines that point, and also generates a guidance text prompting the user for additionally required information, such as “Please specifically tell me a purpose of use and a range of use” or “Please specify a type of target data for which AI is used”. For example, in response to an input “I want to consult about data taking-out”, an additional question such as “Please tell me a data type to be taken out (personal information, confidential information, general information, etc.) and a taking-out method (USB, cloud storage, email attachment, etc.)” is automatically generated. Furthermore, when the user inputs additional information, a loop process of cooperating with the information reference unit again and generating an optimal response text is realized. Specifically, the generative AI processing unit includes a missing information determination module. The missing information determination module compares and collates the input consultation content with a mandatory requirement list of a corresponding guideline. The missing information determination module holds the mandatory requirement list on a memory as a key-value type data structure. The missing information determination module extracts an entity from the consultation content using a named entity extraction model. The missing information determination module calculates a set difference between an extracted entity group and a key group of the mandatory requirement list. When a difference exists, the missing information determination module logically determines that information is missing. Based on this determination result, the generative AI processing unit constructs a question generation prompt for filling a missing key (for example, “data type”, “taking-out method”). The generative AI processing unit inputs this prompt to a language model. The generative AI processing unit outputs an additional question text to be presented to the user and a data type of an expected response (for example, “enumerated type”, “free description type”) as output data. As a specific example of the output data, a text “Please select a data type” and metadata “enumerated type: personal information, confidential information” can be cited. The system uses this output result for dynamic generation of a user interface. When the expected data type is an enumerated type, the system renders a drop-down list instead of a text box on a screen. When the user inputs additional information, the system merges new input data into context information held by a session management unit. The system re-executes a pipeline of information reference and response generation using the updated context information. The system thus implements a loop process functioning as a state transition machine. The system collects information stepwise while maintaining a context of a dialogue. The system thereby significantly improves a resolution rate for a consultation involving a complex conditional branch, compared to a static question-and-answer system. As a specific application field of the system, an online medical questionnaire system in a medical institution can be cited. The system dynamically generates an additional question according to an initial symptom of a patient, and realizes highly accurate triage.

In addition, when a plurality of guidelines or past cases correspond, the generative AI automatically evaluates importance and relevance of each, and generates a response text including prioritized information. For example, when both “Generative AI Use Guidelines” and “Information Security Basic Regulations” correspond, a guideline having the highest relevance to the consultation content of the user is preferentially presented, and a plurality of guidelines are written together as necessary. Furthermore, when a plurality of past consultation cases exist, cases are presented in descending order of similarity, and past responses to the respective cases are also presented together, thereby increasing a possibility that the user can solve it by himself/herself. For example, even for a complex consultation such as “I want to outsource data analysis using AI, but what kind of security measures are necessary?”, it is possible to cross-refer to a plurality of regulations such as guidelines regarding outsourcing, AI use regulations, and data taking-out regulations, and generate a response covering specific procedures and points to note. Specifically, the generative AI processing unit includes a multi-document integration module. The multi-document integration module receives a plurality of document chunks returned from the information reference unit. The multi-document integration module applies an attention mechanism to each chunk. The multi-document integration module calculates an inner product of a query vector of the consultation content and a vector of each chunk to calculate an attention score. The multi-document integration module uses this attention score as a quantitative index of relevance. The multi-document integration module further multiplies a static importance weight (for example, 1.5 for basic regulations, 1.0 for individual regulations) assigned to each document to calculate a final ranking score. The multi-document integration module sorts a document group in descending order based on this ranking score. The generative AI processing unit truncates the sorted document group so as to fit within a limit of a context window. The generative AI processing unit inputs the truncated document group to a language model as an integrated prompt. The generative AI processing unit generates a summary text in which contradictions and duplications among a plurality of regulations are automatically resolved by inference of the language model. The generative AI processing unit outputs a structured response JSON object as output data. As a specific example of the output data, JSON data including a main response text, a list of referred regulations, and an array of similar cases can be cited. The system parses this output result to construct a visually hierarchized response screen on a user interface. The system thus combines a high-dimensional vector operation and heuristic weighting. The system executes cross-reading and integration of a plurality of materials, which are performed by a human expert, at high speed and accurately by a computer science approach. The system thereby prevents oversight of information and guarantees comprehensiveness of a response. As a specific application field of the system, a loan examination support system in a financial institution can be cited. The system integrally analyzes a plurality of information sources such as financial data of a customer, industry trends, and internal examination criteria to generate a comprehensive risk evaluation report.

The log management unit records all consultation contents, response contents, additional questions, input histories from users, guideline reference histories, detailed logs of a response generation process by AI, and the like in chronological order. For example, when a certain user consults “I want to use AI”, the AI asks an additional question “Please tell me a purpose of use”, the user inputs “customer data analysis”, and a final response becomes “When using AI for customer data analysis, please also comply with personal information protection regulations”, all of these series of exchanges are recorded. The log management unit also includes search, aggregation, and analysis functions so that an administrator can analyze consultation trends later and utilize them for revision of guidelines and automatic generation of FAQs. Specifically, the log management unit adopts an event-driven logging architecture. Each module in the system asynchronously publishes an event message to a message queue every time an execution state of a process changes. The log management unit subscribes to the event message from this message queue. The log management unit writes the received message to a time-series database. The log management unit assigns a time stamp, a session ID, a module identifier, and payload data to each log entry. The log management unit serializes and stores an input text, a generated prompt, an output token probability of a language model, an ID list of referred documents, and the like in a JSON format as the payload data. The log management unit thus persists an internal state of an inference process of the AI in a completely traceable form. The log management unit provides a technical foundation for fulfilling accountability for a behavior of a neural network that tends to be a black box. The log management unit periodically executes a batch process on accumulated log data. The log management unit groups vector representations of consultation contents using a clustering algorithm (for example, K-Means method or DBSCAN). The log management unit automatically extracts frequently appearing topics from this clustering result. The log management unit stores an extracted topic group in a relational database as FAQ candidate data. The system thus includes a self-evolving mechanism that automatically constructs a new knowledge base from accumulated data, not limited to mere data recording. The system thereby significantly reduces maintenance man-hours of a system administrator. As a specific application field of the system, a customer behavior analysis system in an e-commerce site can be cited. The system multi-dimensionally analyzes logs of a user's search history and purchase history, and uses them for continuous improvement of a personalized product recommendation algorithm.

The administrator interface unit provides a dedicated screen for a system administrator or a person in charge of information security to perform updating of guidelines and a past case database, tuning of an AI model, analysis of consultation trends, monitoring of a usage status, access authority management, and the like. For example, new addition of guidelines and management of revision histories, tagging of past cases, quality evaluation of response contents by AI, blacklisting of specific consultation contents, access control for each user, and the like are realized. Specifically, the administrator interface unit is implemented as a single-page application. The administrator interface unit communicates with a backend server via a RESTful API. The administrator interface unit renders statistical data aggregated by the log management unit as a graph or a chart on a dashboard using a data visualization library. The administrator interface unit provides a tuning function of an AI model. The system has a function for an administrator to assign a feedback label of “good” or “bad” to a specific response on a screen. The system accumulates this feedback data as training data. The system updates a reward model of a language model using a human feedback method from reinforcement learning. The system executes a proximal policy optimization algorithm to fine-tune weight parameters of the language model. The system thus continuously improves domain-specific response quality. The administrator interface unit includes a blacklist management module. The system compiles a prohibited keyword or a regular expression pattern input by an administrator and caches it on a memory. When an input text of a user matches this pattern, the system forcibly blocks routing to the AI processing unit. The system executes a hard-coded exception handling that immediately returns a standard error message. The system thereby prevents waste of computational resources and physically eliminates a security risk. The system implements a role-based access control model. The system dynamically switches display/non-display of a UI component on a screen according to an authority level of an administrator. As a specific application field of the system, a security operation center of a large-scale network can be cited. The system provides an integrated view of threat intelligence to an analyst, and supports orchestration of incident response.

Utilization of generative AI is diverse, including not just simple keyword searches or standard text responses, but context understanding of consultation contents, summarization and reconstruction of guidelines and cases, automatic generation of additional questions, integration of a plurality of pieces of information, optimization of expressions, personalization for each user, utilization of consultation histories, automatic analysis of consultation trends, and the like. For example, even for the same consultation of “AI use application”, an optimal response text and an additional question are automatically generated according to a department and a job title to which a user belongs, a past consultation history, and a difference in expression at the time of input. Furthermore, the generative AI also has a function of automatically detecting confidential information and personal information included in the consultation content, and performing masking and anonymization as necessary. Specifically, the generative AI processing unit executes a context-aware inference pipeline. At the start of a user's session, the system acquires attribute information (department code, job title level, year of joining the company, etc.) of the user from a human resources database via an API. The system embeds this attribute information in a system message area of a prompt. The system assigns a role to a language model that “you are an agent that generates a response with a tone and manner tailored to a literacy level of a target person”. The system thereby realizes dynamic output control such as explaining detailed procedures in plain words to a new employee, and generating a concise response using technical terms to an information system department member. The generative AI processing unit incorporates a data sanitization module for personal information protection in a preprocessing stage. The data sanitization module scans an input text using a named entity recognition model. The data sanitization module receives a sequence of characters as input data. The data sanitization module outputs a sequence of probabilities that each character belongs to a personal information class as output data. The system specifies a character string portion where this probability exceeds a threshold value. The system replaces the specified character string with a placeholder token such as “personal name placeholder” or “organization name placeholder”. The system inputs only a safe text for which this masking process has been completed to a subsequent language model. The system thus technically blocks a risk that confidential data is transmitted to an AI model on a cloud. The system is not merely a tool for business efficiency improvement, but an advanced information processing apparatus that guarantees data security and privacy protection at a level of a computer architecture. As a specific application field of the system, an automatic analysis system for customer response logs in a financial institution can be cited. The system reliably conceals sensitive information such as an account number and a personal identification number, and then safely extracts trends of customer dissatisfaction and requests.

Regarding realization of each part of the system in a server and a terminal, a consultation reception unit, an information reference unit, a generative AI processing unit, a log management unit, and an administrator interface unit are all realized on a server side. On a terminal side, only a user interface for a user to input a consultation content and receive and display a response from the server is implemented. For example, the terminal side operates as a web browser or a dedicated application, and communication with the server is performed using a secure protocol such as HTTPS. On the server side, high-performance computational resources (GPU, etc.) for executing a generative AI model are prepared so as to be able to respond to simultaneous consultations from a plurality of users in real time. The server can be configured as an on-premises type installed in an internal network or operated on a cloud service, and can be flexibly selected according to security requirements and operation policies. Specifically, the system adopts a thin client architecture. The terminal side executes a lightweight front-end application written in HTML, CSS, and JavaScript. The terminal side does not perform complex data processing or state management, and specializes in a process of listening to a state update event from the server and redrawing a DOM tree. The server side is constructed based on a microservices architecture. The server side packages each functional unit as an independent container image. The server side deploys these containers on a cluster using a container orchestration tool. The server side allocates a parallel computing cluster using GPUs equipped with tensor cores to a node hosting the generative AI processing unit. The server side queues inference requests and applies a dynamic batching algorithm. The server side combines a plurality of independent requests into a single tensor matrix and transfers it to the GPU. The server side thereby maximizes a memory bandwidth of the GPU and an operation rate of computing units. By this hardware-level optimization, the system reduces a calculation latency accompanying inference of a large language model to a millisecond unit. The system prevents a decrease in throughput even under a high load, and maintains a real-time dialogue experience. The server side includes a load balancer. The load balancer executes an auto-scaling function of dynamically scaling out or scaling in the number of container replicas according to an increase or decrease in traffic. The system thus optimizes utilization efficiency of computational resources and minimizes operation costs. As a specific application field of the system, a company-wide common internal portal system in a global enterprise can be cited. The system provides a low-latency response to simultaneous accesses from bases around the world in cooperation with geographically distributed edge servers.

Furthermore, the generative AI automatically records logs of consultation contents and response contents so that they can be utilized for future guideline revisions and consultation trend analysis. For example, when consultations regarding a specific guideline rapidly increase, a function of notifying an administrator and a function of automatically converting frequent consultation contents into an FAQ can also be implemented. In addition, the generative AI considers confidentiality of the consultation content and personal information protection, and also performs automatic anonymization and access control of the consultation content as necessary. For example, when a personal name, a customer name, a confidential project name, or the like is included in the consultation content, the corresponding part is automatically masked and hidden when displayed in a log or on an administrator screen. Specifically, the system implements a trend monitoring module using an anomaly detection algorithm. The trend monitoring module extracts an appearance frequency vector for each consultation category for a certain period (for example, the past 24 hours) from a log database. The trend monitoring module calculates a Euclidean distance between this frequency vector and a past moving average vector. When this distance exceeds a threshold of a statistical standard deviation (for example, 3 sigma), the trend monitoring module mathematically determines that consultations regarding a specific topic are rapidly increasing. The trend monitoring module activates an alert generation process using this determination result as a trigger. The alert generation process extracts a representative consultation text of the rapidly increasing topic, and transmits a notification message to an email address of the administrator via an SMTP protocol. In this way, the system replaces a conventional operation process in which a human manually monitors logs with an automated monitoring system based on statistical processing. Thereby, the system discovers a potential security risk and an operational bottleneck in an organization at an early stage. In the automatic anonymization processing, the system applies rule-based regular expression matching and machine learning-based named entity extraction in a hybrid manner. The system detects data having a fixed format such as a credit card number or an individual number at high speed by a regular expression, and probabilistically detects a context-dependent project name or an unregistered proper noun by a machine learning model. The system holds index information of the detected character string as metadata. When there is a log display request, the system evaluates an access authority level of a request source. When the authority is insufficient, the system executes dynamic masking processing of overwriting a corresponding byte sequence on a text stream with an asterisk character based on the index information. As a specific application field of the system, an internal reporting management system in an auditing firm can be cited. The system highlights signs of organizational fraud by data analysis while cryptographically and systemically protecting anonymity of a reporter.

As described above, the embodiment of the present invention realizes a wide range of effects such as efficiency improvement of information security consultation work, uniformization of response quality, reduction of work load, prompt response, improvement of a self-resolution rate, and analysis and feedback of consultation trends by using the generative AI as a core, comprehensively utilizing internal regulations, guidelines, and past cases, and automatically generating an optimal response and an additional question in accordance with the consultation content of the user. For example, even when a new guideline regarding AI use is added, a response based on the latest regulation is immediately generated simply by updating a database on a server side, so that high flexibility and expandability are provided in terms of operation. In addition, further expansion such as multilingual support for consultation contents, an accessibility function for persons with disabilities, support for voice input and voice output, chatbot and email linkage, and API linkage with an external system is also easy. For example, even when a user at an overseas base consults in English, the generative AI can automatically translate and present appropriate guidelines and responses in multiple languages. Furthermore, advanced functions for an administrator, such as automatic classification of consultation contents by AI, automatic determination of a risk level, an escalation function according to an urgency level, statistical analysis of consultation contents, and dashboard display, can also be implemented. Specifically, the system adopts a dynamic knowledge base integration architecture. The system cooperates with an external document management system via a Webhook. When receiving an event of adding a new guideline or updating an existing regulation, the system activates a background worker process. The worker process acquires the updated document, and automatically executes a pipeline of text extraction, chunk division, and vectorization. The worker process upserts the generated new vector data into a vector database. In this way, the system realizes an immediate update of knowledge without accompanying re-learning (fine tuning) of a model. Thereby, the system solves obsolescence of information, which is the biggest problem in operation of a machine learning model, with high calculation efficiency by a retrieval-augmented generation technology. The system incorporates a neural machine translation model into the pipeline as a multilingual support module. The system automatically determines a language of an input text using an N-gram language model. When the input is a non-standard language (for example, English), the system converts the input into an intermediate language (for example, Japanese) using a translation model, and then executes information reference and response generation processing. The system back-translates the generated response text into the original language again and outputs the back-translated response text. In this way, the system realizes global multilingual support with a single language model and knowledge base, and eliminates duplication of system resources. The system includes an automatic risk level determination module. The module inputs a text vector of the consultation content to a support vector machine, and performs regression prediction of severity of an information leakage risk as a continuous value score from 0 to 100. When this score exceeds an emergency threshold, the system bypasses a normal response generation process and automatically issues an emergency ticket to an incident management system via a REST API. As a specific application field of the system, a global integrated help desk in a multinational corporation can be cited. The system provides uniform and high-quality support to all employees across language barriers and time differences.

### System Configuration

The system according to the present embodiment includes a consultation reception unit, an information reference unit, a generative AI processing unit, a log management unit, an administrator interface unit, a user interface unit, and a security control unit. The consultation reception unit has a function of receiving a consultation content regarding information security input from a terminal by a user, and recording this on a server together with metadata such as a time, user identification information, a terminal type, and a consultation category. For example, when the user inputs “I want to use generative AI for business, but what kind of procedure is necessary?”, the consultation reception unit receives this content, automatically issues a consultation ID, and stores the consultation content, a reception time, and user information in a database. Furthermore, the consultation reception unit automatically presents a correction candidate when there is a typographical error or a deficiency in the input content, and automatically performs category classification using the generative AI when the consultation content spans a plurality of categories. For example, it is possible to cope with a complex content such as “I want to consult about both AI use and data taking-out”. In addition, the consultation reception unit also provides a function enabling the user to refer to a past consultation history, draft saving of a consultation content, template selection of a consultation content, automatic summarization of a consultation content, and the like. Specifically, the system containerizes a module group based on a microservice architecture and executes the containerized module group on an orchestration platform. The consultation reception unit functions as an API gateway, and routes a request from the outside to an appropriate internal service. The consultation reception unit extracts a JWT (JSON Web Token) from a header of the received HTTP request and performs signature verification. The consultation reception unit mathematically guarantees authentication and authorization of the user by this verification. The consultation reception unit implements a multi-label classification model. The consultation reception unit tokenizes an input text, and inputs the tokenized input text to a transformer-based encoder to generate a context vector. The consultation reception unit inputs this context vector to a plurality of independent sigmoid output layers. The consultation reception unit outputs an independent probability value for each category. As a specific example of the output data, a format of a probability vector such as “AI use: 0.92”, “data taking-out: 0.88”, and “password management: 0.01” can be cited. The consultation reception unit adds all categories exceeding a threshold (for example, 0.5) in this probability vector to a metadata array as corresponding categories. In this way, the system realizes not an exclusive single-class classification but a multi-value classification conforming to an actual complex consultation on a computer. The consultation reception unit executes an extraction-type summarization algorithm as an automatic summarization function. The consultation reception unit calculates a TF-IDF score for each sentence in the input text, extracts a sentence having high importance, and generates a summary text. The system saves this summary text in an index field of the database, and improves performance of subsequent search processing. As a specific application field of the system, a comprehensive consultation counter system from residents in a local government can be cited. The system accurately classifies a complex inquiry spanning a plurality of jurisdictions such as welfare, taxes, and child-rearing, and performs automatic distribution to an appropriate department.

The information reference unit has a function of searching for information related to the consultation content from internal regulations, security-related guidelines, guidelines for AI use, data taking-out regulations, password management regulations, outsourcing regulations, cloud use regulations, a past consultation case database, and the like stored in the storage device in the server. For example, keywords such as “generative AI”, “business use”, and “procedure” are extracted, and guidelines and past consultation cases corresponding to these are searched at high speed. The information reference unit utilizes not only simple keyword matching but also semantic similarity determination using a natural language processing technology by the generative AI, and copes with consultation contents having different expressions such as “I want to use AI”, “application method for AI use”, and “points to note when introducing AI”. Furthermore, the information reference unit also considers a revision history, an expiration date, and an application range (company-wide application, specific department limitation, etc.) of a guideline, and extracts only the latest and appropriate information. For example, when the “guidelines for AI use” have been revised in the past, contents before and after the revision are compared, and a guideline of a version most suitable for the consultation content is presented. When a plurality of guidelines and cases correspond, the information reference unit automatically evaluates relevance and importance, and outputs prioritized information. Specifically, the information reference unit implements a hybrid search algorithm. The information reference unit executes a sparse vector search based on a BM25 algorithm and a dense vector search based on a neural network in parallel. The information reference unit specifies a perfect match of a specific technical term or product name at high speed by the sparse vector search. The information reference unit calculates similarity of contextual meaning as a cosine distance in a high-dimensional space by the dense vector search. The information reference unit integrates scores of these two search results using a reciprocal rank fusion algorithm. By this integration processing, the information reference unit realizes search accuracy that is difficult to achieve by a single method, which is to ensure semantic relevance while preventing omission of keywords. The information reference unit cooperates with a version-controlled document store. The information reference unit holds a valid start date and time and a valid end date and time as metadata of each document. When executing a search query, the information reference unit dynamically binds a timestamp of a current time to a WHERE clause of SQL to perform filtering. Furthermore, when the consultation content of the user relates to a specific past event, the information reference unit extracts a time expression (for example, “in April of last year”) from the consultation text by natural language processing. The information reference unit executes a time travel search for specifying a version of a valid guideline at that time based on this extracted time information. In this way, the system realizes a dynamic information search considering a time axis on a computer. The information reference unit generates an array of document objects sorted by search scores as output data. As a specific example of the output data, a JSON array including a document ID, a title, a highlighted text snippet, and an integrated score (for example, 0.89) can be cited. As a specific application field of the system, a prior art search system in a patent office can be cited. The system extracts a document having a similar technical idea even if keywords are different from a huge amount of patent documents with high accuracy.

The generative AI processing unit has a function of receiving the guidelines and past cases extracted by the information reference unit and the consultation content of the user as inputs, and generating an optimal response text using a natural language processing model. For example, a specific response based on contents of the guidelines and past cases, such as “Application to an information security department is necessary for business use of generative AI, and an examination is performed after submission of an application form”, is automatically generated. The generative AI processing unit summarizes contents of the extracted guidelines and cases, and converts them into appropriate expressions in accordance with the consultation content. For example, article citation such as “Based on Article 3 of the guidelines for AI use, prior application is essential at the time of business use” and specific case introduction such as “There was a similar consultation in the past, and an entry example of an application form is as follows” are also automatically performed. Furthermore, when the consultation content has ambiguity or missing information, the generative AI processing unit automatically determines that point, and also generates a guidance text prompting the user for additionally required information, such as “Please specifically tell me a purpose of use and a range of use” or “Please specify a type of target data for which AI is used”. For example, in response to an input “I want to consult about data taking-out”, an additional question such as “Please tell me a data type to be taken out (personal information, confidential information, general information, etc.) and a taking-out method (USB, cloud storage, email attachment, etc.)” is automatically generated. Furthermore, when a plurality of guidelines and past cases correspond, the generative AI processing unit automatically evaluates relevance and importance of each, and generates a response text including prioritized information. For example, when both the “guidelines for generative AI use” and the “basic regulations for information security” correspond, a guideline having the highest relevance to the consultation content of the user is preferentially presented, and a plurality of guidelines are written together as necessary. The generative AI processing unit can also generate a personalized response and additional question based on a consultation history and attribute information of the user. For example, for a user who has made an “application for AI use” in the past, an individual response such as “Is it the same purpose of use as the previous time?” is also possible after referring to the previous application content. Specifically, the generative AI processing unit includes a dynamic template engine based on prompt engineering. The generative AI processing unit receives a consultation text of the user, a text array of searched documents, and a past session history vector of the user as input data. The generative AI processing unit maps this input data to a structured prompt format. The generative AI processing unit inputs this prompt to a large-scale language model having billions of parameters. The generative AI processing unit sets a temperature parameter to a low value (for example, 0.1) in an inference process of the model. By this parameter control, the system suppresses randomness of an output of the model, and forces deterministic text generation based on facts. The generative AI processing unit outputs a response text, a document ID list of a citation source, and an enumerated code of an action to be taken next as output data. As a specific example of the output data, a text “Prior application is necessary”, an ID “doc_123”, and a code “ACTION_REQUIRE_INFO” can be cited. The system evaluates this action code, and when determining that it is a state where additional information is necessary, calls a dialogue management module to start slot filling processing. The dialogue management module specifies a missing information slot (for example, “data type”), and generates a question text for filling the slot. The system issues an SQL query to a past application history database of the user, and acquires a previous application record. The system embeds a value of this record into the prompt as a default value. In this way, the system reuses a past context, and realizes personalization processing for minimizing an input load of the user on a computer. The system functions not as a mere text generator but as a state-holding dialogue agent. As a specific application field of the system, an automatic guidance system for accident reception and insurance claim in an insurance company can be cited. The system dynamically refers to contract contents and a past claim history of a customer, and guides an accurate procedure based on complex stipulations in a dialogue format.

The log management unit has a function of recording all consultation contents, response contents, additional questions, input histories from users, guideline reference histories, detailed logs of a response generation process by AI, and the like in chronological order. For example, when a certain user consults “I want to use AI”, the AI asks an additional question “Please tell me a purpose of use”, the user inputs “customer data analysis”, and a final response is “When using AI for customer data analysis, please also comply with personal information protection regulations”, all of these series of exchanges are recorded. The log management unit also includes search, aggregation, and analysis functions so that an administrator can analyze consultation trends later, and utilize them for guideline revisions and automatic generation of FAQs. For example, when consultations regarding a specific guideline rapidly increase, a function of notifying an administrator and a function of automatically converting frequent consultation contents into an FAQ can also be implemented. Furthermore, the log management unit considers confidentiality of the consultation content and personal information protection, and also performs automatic anonymization and access control of the consultation content as necessary. For example, when a personal name, a customer name, a confidential project name, or the like is included in the consultation content, the corresponding part is automatically masked and hidden when displayed in a log or on an administrator screen. Specifically, the log management unit constructs a high-throughput log collection pipeline using a distributed messaging system. The log management unit temporarily saves a log event asynchronously transmitted from each microservice in an in-memory buffer. The log management unit bulk-extracts data from this buffer for each certain chunk size, and writes the data into a persistent storage. By this batch processing, the system reduces an overhead of disk I/O, and improves a processing speed of the entire system. The log management unit periodically executes topic modeling (for example, latent Dirichlet allocation) using natural language processing on log data. By this algorithm, the log management unit mathematically estimates a distribution of hidden topics from a large amount of text logs. The log management unit analyzes a temporal change of this topic distribution, and detects occurrence of a trend when a probability weight of a specific topic rapidly increases. In this way, the system automates trend analysis of large-scale data, which is impossible by human visual inspection. In data masking processing, the log management unit applies one-way encryption using a hash function. The system adds a salt to the detected personal information character string, and then calculates a SHA-256 hash. The system replaces the original character string with this hash value and saves it in the database. In this way, the system completely irreversibilizes original information while maintaining referential integrity of data. Thereby, the system mathematically eliminates a risk of privacy leakage while enabling tracking analysis of logs regarding the same person. As a specific application field of the system, a sign detection system for a network failure in a communication carrier can be cited. The system automatically detects a rapid increase of a specific error pattern from a huge amount of device logs, and prevents occurrence of a large-scale failure.

The administrator interface unit provides a dedicated screen for a system administrator or an information security person in charge to perform updating of guidelines and a past case database, tuning of an AI model, analysis of consultation trends, monitoring of a usage status, access authority management, and the like. For example, new addition of guidelines, management of a revision history, tagging of past cases, quality evaluation of response contents by AI, blacklisting of specific consultation contents, access control for each user, and the like are realized. The administrator interface unit also includes statistical analysis of consultation contents and response contents, dashboard display, graphing of consultation trends, feedback input for improving response accuracy of AI, automatic determination of a risk level of a consultation content, an escalation function according to an urgency level, and the like. Specifically, the administrator interface unit is a web application constructed using a reactive programming paradigm. The administrator interface unit establishes a bidirectional communication channel with a back-end server using a WebSocket protocol. The administrator interface unit receives an operation status of the system and a new consultation event in real time through this channel, and dynamically updates a screen of a browser without reloading. The administrator interface unit provides a data grid component, and enables the administrator to directly perform a CRUD operation on a record of the past case database. The administrator interface unit provides an A/B test environment for prompts as a tuning function of the AI model. The system executes a plurality of prompt variants input by the administrator in parallel, and statistically compares evaluation scores of users for respective output results. In this way, the system supports a process of determining an optimal prompt parameter in a data-driven manner. The administrator interface unit visualizes an output of the automatic risk level determination module. The system highlights a consultation session whose risk score exceeds a threshold in red, and fixes it at the top of the screen. When the administrator clicks the session, the system pop-up displays a detailed log trace and an inference basis of AI (such as an attention weight distribution). In this way, the system provides visibility and explainability for a determination process of AI that is easy to become a black box. As a specific application field of the system, a security incident response platform in a cloud service provider can be cited. The system presents an overall picture of a threat to a security operator in real time, and supports prompt decision-making and response action.

The user interface unit provides a screen and an operation procedure for a user to input a consultation content from a terminal and receive and display a response from a server. For example, a text box “Please input a consultation content”, a “Send” button, a link for referring to a past consultation history, a shortcut to an FAQ, a copy/save/print function of a response content, an immediate response function to an additional question, support for voice input and voice output, an accessibility function, and the like are implemented on a screen of the terminal. The user interface unit also provides input assistance, automatic completion, template selection, automatic summarization of an input content, multilingual support for an input content, and the like in accordance with attributes and a past usage history of the user. Specifically, the user interface unit exchanges data with the server using AJAX, which is an asynchronous communication technology. Every time the user inputs a character into the text box, the user interface unit captures a key-up event and acquires an input character string. The user interface unit transmits this character string to a suggest API of the server as a query parameter. The server executes a forward match search at high speed using a trie tree data structure, and returns a list of predicted words and phrases. The user interface unit renders this list on the screen as a drop-down menu, and physically reduces an input operation of the user. The user interface unit implements a voice recognition function using a Web Speech API. The user interface unit converts a voice stream acquired from a microphone of the terminal into digital waveform data. The user interface unit inputs this waveform data to an acoustic model and a language model, and decodes it into a text character string. In this way, the system provides an alternative input means by computer technology to a user unfamiliar with keyboard operation or a user requiring accessibility. The user interface unit parses a JSON payload of the response received from the server. The user interface unit interprets a markdown notation and an HTML tag included in the response text, and draws them on the screen as a rich text format such as bold, bullet points, and hyperlinks. The user interface unit calculates a cosine similarity between a past usage history vector of the user and a current input context. Based on this similarity, the user interface unit dynamically rearranges and presents a consultation template having the highest relevance. As a specific application field of the system, an internal concierge service provided as a native application of a smartphone can be cited. The system overcomes a narrow screen and input restrictions peculiar to a mobile environment by advanced UI/UX technology and prediction capability of AI.

The security control unit performs encryption of communication, access authority management, login authentication, data masking/anonymization, authority control at the time of saving/referring to a consultation content, confidential information detection by AI, a security check at the time of external system linkage, and the like in order to ensure information security of the entire system. For example, a secure protocol such as HTTPS is used for communication between the server and the terminal, guidelines and consultation histories accessible for each user are limited, and acquisition of an audit log and unauthorized access detection by an administrator are also implemented. The security control unit is also responsible for automatic classification and risk level determination of consultation contents by AI, automatic notification to an administrator according to an urgency level, a security check at the time of data linkage with an outsourcing contractor, and the like. Specifically, the security control unit is designed based on principles of a zero trust architecture. The security control unit encrypts all network communications end-to-end using a transport layer security protocol. The security control unit mathematically guarantees confidentiality and integrity of communication by combining key exchange by a public key cryptosystem and data encryption by a common key cryptosystem. The security control unit implements OAuth 2.0 and OpenID Connect protocols, and executes federation authentication in cooperation with an external identity provider. The security control unit verifies an access token issued upon successful authentication, and executes authorization determination for each request in units of microseconds. The security control unit executes a pipeline in which a regular expression engine and a machine learning-based classifier are arranged in series for confidential information detection. The security control unit extracts fixed-format data such as a credit card number from an input text by pattern matching. The security control unit further vectorizes the text, inputs it to a support vector machine, and probabilistically determines highly confidential project information or the like from a context. Based on this determination result, the security control unit replaces the corresponding character string with an irreversible hash value before writing to a database. The security control unit executes static analysis on a payload to be transmitted at the time of linkage with an external API. The security control unit inspects whether an attack signature of SQL injection or cross-site scripting is included in the payload. In this way, the system constructs multi-layer defense from an application layer to a network layer on a computer system. As a specific application field of the system, an information sharing system in a closed network environment handling highly confidential information in a government agency or a defense industry can be cited. The system provides a robust defense mechanism against an internal crime and a cyber attack from the outside.

Specific examples of prompt texts to be read by the generative AI when implementing the present invention include, for example, “Generate an optimal response text to the following consultation content by referring to internal regulations, guidelines, and past consultation cases. Consultation content: ‘I want to use generative AI for business, but what kind of procedure is necessary?’”, “Generate a guidance text asking a user for necessary additional information for the following consultation content. Consultation content: ‘I want to consult about data taking-out’”, “When there are a plurality of related guidelines and past cases for the following consultation content, evaluate relevance and importance, and generate a prioritized response text. Consultation content: ‘I want to outsource data analysis using AI, but what kind of security measures are necessary?’”, and “When a consulter has made a similar consultation in the past for the following consultation content, refer to a past consultation history and generate a personalized response text. Consultation content: ‘I want to apply for AI use again’”. These prompt texts are indispensable for the generative AI to deeply understand the context and intention of the consultation content, comprehensively utilize the internal regulations, the guidelines, and the past cases, and automatically generate a response and an additional question optimized for each user. Specifically, the system manages these prompt texts on a memory not as static character strings but as dynamically assembled template objects. The system includes a prompt generation module. The prompt generation module combines three sections of a system prompt, context data, and a user query to construct a final input tensor. The prompt generation module arranges a meta-instruction (for example, “You behave as an information security expert” or “Output is limited to a JSON format”) defining a behavior of a language model in the system prompt section. The prompt generation module sorts a document chunk group acquired from the information reference unit in descending order of a relevance score and inserts the document chunk group into the context data section. The prompt generation module arranges an actual input text of the user in the user query section. The system inputs the prompt structured in this way to a large language model. The system forcibly focuses a self-attention mechanism of the language model on a specific context. Thereby, the system mathematically suppresses a hallucination phenomenon in which the model generates inaccurate information depending on learning data. The system counts the number of tokens of the prompt, and executes a sliding window algorithm for dynamically truncating the context data so as not to exceed a maximum context window (for example, 4096 tokens) of the language model. In this way, the system performs advanced memory management and data structure optimization for extracting maximum inference accuracy within constraints of limited computational resources. The system implements a data preprocessing pipeline optimized for an internal architecture of a natural language processing model, rather than simple concatenation of character strings. A specific application field of the system includes a precedent search and legal opinion automatic generation system in a law firm. The system structures strict factual relations and complex legal logic as a prompt, and highly supports a drafting task of a lawyer.

### Implementation Steps

Step 1: Input and Reception of Consultation Content The user inputs a consultation content regarding information security using a user interface on the terminal. For example, a specific consultation content or question such as “I want to use generative AI for business, but what kind of procedure is necessary?”, “I want to consult about data taking-out”, or “I want to know regulations for password management” can be input in a free description format. After inputting the consultation content, the user presses a transmission button, and the consultation content is transmitted to the consultation reception unit of the server. The consultation reception unit records the received consultation content in a database together with metadata such as a time, user identification information, a terminal type, and a consultation category. When there is a typographical error or a deficiency in the input content, automatic correction or presentation of a correction candidate by AI is also performed. Specifically, the terminal of the system acquires character string data input by the user via an input device. A processing unit of the terminal converts the acquired character string data into byte array data using a UTF-8 encoding method. A communication unit of the terminal transmits this byte array data to the server via an HTTPS protocol. The consultation reception unit of the server receives the data via a network interface. The consultation reception unit adds time stamp data acquired from a system clock, a user identification ID acquired from a session management unit, and terminal type data extracted from user agent information of the terminal to the received data. The consultation reception unit integrates these data and writes them into a relational database as structured data in a JSON format. Furthermore, the consultation reception unit executes an automatic correction process on the input text data. The processing unit inputs the text data to a morphological analysis engine and divides it into a token sequence in units of words. The processing unit inputs this token sequence to a language model based on a transformer architecture. The language model receives an embedding vector of each token as an input. The language model calculates a context dependency relationship between tokens using a self-attention mechanism. The language model generates an array of correction probability scores for each token as an output. For example, when the input text includes a typographical error “passwod”, the language model outputs a correction candidate character string “password” and a high probability score of 0.95. When the probability score exceeds a preset threshold value of 0.8, the processing unit automatically replaces the corresponding token with the correction candidate character string. The processing unit transfers the replaced text data to a subsequent processing module. By applying such a computer-specific natural language processing algorithm, the system automatically improves the quality of the input data inside the system. As a result, the system exhibits a technical effect of reducing noise in subsequent category classification and information search processing, and dramatically improving processing accuracy and response speed of the entire system.

Step 2: Automatic Classification and Preprocessing of Consultation Content The consultation reception unit automatically performs category classification and content summarization on the received consultation content using the generative AI. For example, even when the consultation content spans a plurality of categories such as “AI use”, “data taking-out”, “outsourcing”, and “password management”, the generative AI analyzes the context and classifies it into an appropriate category. Furthermore, summarization of the consultation content and keyword extraction are also automatically performed to improve efficiency of subsequent processing. A specific example of a prompt text to be read by the generative AI at this time includes “Classify the following consultation content into categories such as AI use, data taking-out, and password management, and extract a summary and main keywords. Consultation content: ‘I want to use generative AI for business, but what kind of procedure is necessary?’”. Specifically, the consultation reception unit of the server inputs the text data of the received consultation content to a large language model. The model divides the input text data into tokens in units of subwords. The model converts each token into a 512-dimensional word embedding vector. The model processes these vectors using a multi-layer neural network. The model generates an output vector of a softmax function indicating a probability of belonging to each category as an output. For example, the output vector includes numerical data such as a probability of the AI use category being 0.85, a probability of the data taking-out category being 0.10, and a probability of the password management category being 0.05. When a maximum probability value in this output vector exceeds a preset threshold value of 0.8, the consultation reception unit determines the corresponding category as a main category. When the maximum probability value falls below the threshold value, the consultation reception unit sets flags for a plurality of top categories on a memory. Furthermore, the consultation reception unit activates a summary generation model having an encoder and decoder configuration. The model extracts a context vector with high importance from the input text. The model autoregressively generates and outputs tensor data of a summary text from the extracted context vector. The model simultaneously extracts a named entity in the text and outputs it as list data of keywords. By executing the classification and summarization processing based on vector operations in such a high-dimensional space, the system realizes objective and high-speed data preprocessing that does not depend on human subjectivity. As a result, the system exhibits a technical effect of dynamically limiting a range of a database to be searched in subsequent search processing, and significantly reducing memory consumption and calculation load of a computer.

Step 3: Search and Extraction of Related Information The information reference unit searches for and extracts related information from internal regulations, various guidelines, a past consultation case database, and the like based on keywords and category information of the consultation content. For example, corresponding documents and articles, and past similar consultation cases such as “generative AI use guidelines”, “information security basic regulations”, “data taking-out regulations”, and “password management regulations” are searched at high speed. Not only keyword matching but also semantic similarity determination by the generative AI is used for a search algorithm. For example, even when expressions are different, such as “I want to use AI”, “application method for AI introduction”, and “points to note when utilizing AI”, the generative AI performs semantic analysis and extracts appropriate information. Specifically, the information reference unit of the server inputs the extracted keywords and summary text data to a sentence embedding model. The model converts the input text data into a query vector, which is a 768-dimensional dense numerical vector, and outputs the query vector. On the other hand, a document vector group obtained by converting each paragraph text of the internal regulations and the guidelines in advance using the same model is stored as a vector database in the storage device of the server. The information reference unit calculates a cosine similarity between the generated query vector and each document vector in the database. The information reference unit sorts the calculated similarity scores in descending order. The information reference unit outputs a list of pairs of a document ID and a score for which the similarity score is in the top N. For example, the output data includes information such as a pair of a similarity score of 0.92 and a document ID 001, and a pair of a similarity score of 0.88 and a document ID 005. The information reference unit reads text data of the corresponding document from a relational database based on the extracted document ID. The information reference unit loads the read text data into a context memory area of the generative AI processing unit. By using an algorithm that quantifies a semantic feature amount as a distance in a vector space instead of such a simple character string matching search, the system absorbs fluctuations in input expressions of the user. As a result, the system exhibits a technical effect of preventing search omissions, mathematically ensuring accuracy of information extraction, and shortening a time required for search processing to a millisecond unit.

Step 4: Generation of Optimal Response Text The generative AI processing unit receives the extracted guidelines and past cases, and the consultation content of the user as inputs, and generates an optimal response text using a natural language processing model. For example, a specific response based on contents of the guidelines and the past cases, such as “Application to an information security department is necessary for business use of generative AI, and an examination is performed after submission of an application form”, is automatically generated. When a plurality of guidelines and cases correspond, relevance and importance are automatically evaluated, and a response text including prioritized information is generated. A specific example of a prompt text to be read by the generative AI includes “Generate an optimal response text to the following consultation content by referring to internal regulations, guidelines, and past consultation cases. Consultation content: ‘I want to use generative AI for business, but what kind of procedure is necessary?’”. Specifically, the generative AI processing unit of the server includes an autoregressive large language model based on a transformer architecture. The processing unit combines system prompt data, a text data group of the guidelines extracted by the information reference unit, and consultation content text data of the user. The processing unit converts the combined text data into a token sequence and inputs it to the language model. The language model calculates an attention weight matrix indicating a dependency relationship between all input tokens using an internal self-attention mechanism. The language model continuously outputs a probability distribution of a next word constituting the response text based on this weight matrix. The processing unit executes a beam search algorithm, and selects a path of words having the highest cumulative probability from the continuation of the output probability distributions. The processing unit outputs the selected path as response text data. When a plurality of guidelines correspond, the processing unit calculates a sum of attention scores for the text of each guideline. The processing unit controls a generation process so as to preferentially arrange information of a guideline having a large sum of scores at a head portion of the response text. For example, the language model extracts important entities “prior application” and “examination” from the input token sequence of the regulation document, and outputs response text data in which these are logically connected. By applying such a computer-specific probabilistic generation algorithm, the system completely eliminates a mental process in which a human reads and understands a plurality of documents to create a response. As a result, the system exhibits a technical effect of instantaneously generating an accurate response compliant with complex internal regulations, and dramatically reducing a business load on the information security department.

Step 5: Additional Information Request and Interactive Response When the consultation content has ambiguity or missing information, the generative AI processing unit automatically determines that point, and generates a guidance text prompting the user for additionally required information. For example, a specific additional question such as “Please specifically tell me a purpose of use and a range of use” or “Please specify a type of target data for which AI is used” is automatically generated. When the user inputs additional information, a loop process of cooperating with the information reference unit again and generating an optimal response text is realized. A specific example of a prompt text to be read by the generative AI includes “Generate a guidance text asking a user for necessary additional information for the following consultation content. Consultation content: ‘I want to consult about data taking-out’”. Specifically, the generative AI processing unit of the server activates an internal evaluation module for verifying completeness of the generated response text data. The module acquires list data of essential input items necessary for a procedure from metadata of the extracted guidelines. For example, in the case of data taking-out regulations, an essential input item list includes elements of a purpose of use, a target data type, and a taking-out method. The module applies a named entity extraction model to the consultation content text of the user, and extracts an already input entity. The module executes a set difference operation between the essential input item list and a set of the extracted entities. When a missing item exists as a result of the difference operation, the module determines that it is in an information shortage state. The module constructs a question text generation prompt for filling the missing item, and inputs it to the language model. The language model outputs additional question text data specifically asking about the missing item based on the input prompt. For example, when the target data type is missing, the language model outputs character string data “Please tell me a data type to be taken out”. The processing unit transmits the generated additional question text data to the terminal. The processing unit updates a session state of the user to a standby mode, and holds current context data on a memory. By state machine control combining such logical operations and natural language generation, the system prevents presentation of an erroneous response based on incomplete information at a system level. As a result, the system exhibits a technical effect of improving final response accuracy through interactive information complementation and increasing a self-resolution rate of the user.

Step 6: Presentation of Response Content and History Management The generated optimal response text is presented to the terminal of the user via the user interface unit. The user can confirm the response content and make an additional question or a re-consultation as necessary. All consultation contents, response contents, additional questions, input histories from the user, guideline reference histories, detailed logs of a response generation process by AI, and the like are recorded in chronological order by the log management unit. For example, when a certain user consults “I want to use AI”, the AI asks an additional question “Please tell me a purpose of use”, the user inputs “customer data analysis”, and a final response becomes “When using AI for customer data analysis, please also comply with personal information protection regulations”, all of these series of exchanges are recorded. Specifically, the user interface unit of the server encapsulates the generated response text data into an HTTP response packet. The unit transmits this packet to the terminal of the user via a network communication network. The processing unit of the terminal extracts the text data from the received packet, and renders it on a screen of a display device. At the same time, the log management unit of the server collects transaction data regarding a series of interactive sessions. The collected data includes input text data of the user, a document ID list of the extracted guidelines, prompt data input to the language model, generated response text data, and tensor data of attention scores calculated by the language model. The log management unit serializes these data into structured data in a JSON format. The log management unit adds a time stamp acquired from a system clock as a primary key to the serialized data. The log management unit writes this data into a time-series database in an asynchronous process. For example, the log management unit also records a processing time of each step from a start of consultation to presentation of a final response, and latency data in units of milliseconds required for inference of the language model. By executing such comprehensive data logging processing in the background, the system constructs a complete audit trail on a storage without affecting response performance of the system. As a result, the system exhibits a technical effect of ensuring traceability in an information security audit and automatically accumulating high-quality training data for future AI model re-learning.

Step 7: Operation, Analysis, and Improvement by Administrator Using the administrator interface unit, a system administrator or an information security person in charge performs updating of guidelines and a past case database, tuning of an AI model, analysis of consultation trends, monitoring of a usage status, access authority management, and the like. For example, new addition of guidelines and management of revision histories, tagging of past cases, quality evaluation of response contents by AI, blacklisting of specific consultation contents, access control for each user, statistical analysis of consultation contents and response contents, dashboard display, graphing of consultation trends, feedback input for improving response accuracy of AI, automatic determination of a risk level of a consultation content, an escalation function according to a degree of urgency, and the like are realized. Specifically, the administrator interface unit of the server extracts log data corresponding to a specific period from a time-series database. The unit executes a topic modeling algorithm such as a latent Dirichlet allocation method on a text group of the extracted log data. The unit calculates a numerical vector indicating an appearance frequency of each consultation topic and an unresolved rate score in which additional questions are repeated, as an output of the algorithm. The unit generates JSON data for graph drawing for visualizing these numerical data, and displays it on a dashboard of an administrator terminal. Furthermore, the unit provides a tuning function of the AI model. When the administrator inputs a correction text or a correct answer label for a specific response via the dashboard, the unit adds these feedback data to a training data set. A learning processing unit of the server calculates a cross entropy error, which is a loss function, using this training data set. The learning processing unit executes a gradient descent algorithm, and executes a fine tuning process of finely adjusting a weight parameter matrix of the language model in a direction of minimizing the error. In addition, the unit sets an escalation rule for automatically transmitting an alert mail to the security person in charge when detecting a consultation content including a specific keyword on a memory. By integrating such data-driven analysis and model update processing inside the system, the system dynamically adapts to changes in an operation environment. As a result, the system exhibits a technical effect of realizing continuous improvement of response accuracy and significantly reducing man-hours required for operation and maintenance by the system administrator.

### Specific Use Case

For example, assume a case where an employee belonging to an information system department wants to utilize generative AI for business efficiency improvement, and consults about internal regulations and application procedures. In this case, the employee uses a user interface unit of a terminal, inputs a consultation content such as “I want to use generative AI for business, but what kind of procedure is necessary?”, and performs a transmission operation. A consultation reception unit receives the consultation content, and records it in a database together with metadata such as a time, user identification information, a terminal type, and a consultation category. When the consultation content is received, the consultation reception unit executes automatic classification and summarization of the consultation content using generative AI, and extracts categories and keywords such as “AI use”, “business use”, and “application procedure”. Based on the extracted information, an information reference unit searches for and extracts related documents and cases, such as internal guidelines regarding AI use, basic information security regulations, and past consultation cases regarding AI use applications, at high speed. For example, when it is described in Article 3 of the guidelines regarding AI use that “prior application is essential at the time of business use”, or when a past consultation case “I want to apply for data analysis using AI” exists, such information becomes an extraction target. Specifically, an input device of the terminal operated by the employee detects a keystroke event, and temporarily stores input character string data in a buffer of a memory. A processing unit of the terminal transmits the character string data in the buffer to a server, triggered by a pressing event of a transmission button. The consultation reception unit of the server applies a regular expression filter to the received character string data, and executes a sanitization process of removing an unauthorized control character and a script tag. The consultation reception unit inputs the sanitized text data to an encoder model of the generative AI. The encoder model maps the text data to coordinate data on a 768-dimensional vector space. This model inputs this coordinate data to a multi-class classification layer, and outputs a probability vector including a probability value of each category. For example, the output probability vector includes numerical data such as a probability value of 0.95 for the AI use category and a probability value of 0.88 for the business use category. The consultation reception unit specifies a category whose probability value exceeds a threshold, and holds it in the memory as metadata. Next, the information reference unit constructs the specified category information and the extracted keyword group as query data. Using this query data, the information reference unit activates a hybrid search algorithm that executes a keyword search based on an inverted index and a similarity search based on a vector database in parallel. The information reference unit normalizes and integrates scores of both search results, and extracts document data having a higher total score. By executing such a multi-stage data processing pipeline, the present system converts an ambiguous input intention of a user into an accurate mathematical expression. As a result, the present system exhibits a technical effect of exhaustively and rapidly extracting related provisions and cases from a vast amount of internal regulations.

A generative AI processing unit receives the extracted guidelines and past cases, and the consultation content of the user as inputs, and generates an optimal response text using a natural language processing model. For example, it automatically generates a specific and practical response text such as “Application to an information security department is necessary for business use of generative AI, and an examination is performed after submission of an application form. It is necessary to specify a purpose of use, a range of use, a type of target data, a period of use, and the like in the application form. As a past application case, an example of description in the application form when AI is used in a data analysis business is as follows.” Furthermore, when the consultation content is ambiguous, such as “I want to use AI”, the generative AI processing unit automatically generates an additional question such as “Please tell me specific business contents and a type of target data for which AI is used”, and presents it to the user. When the user inputs “I want to use AI for customer data analysis” as additional information, the generative AI searches for related guidelines and past cases again, and generates a supplementary response such as “When using AI for customer data analysis, it is necessary to comply with personal information protection regulations as well, and to thoroughly implement data anonymization and access control” after referring to the personal information protection regulations and data taking-out regulations as well. Specifically, the generative AI processing unit of the server combines text chunks of the extracted guidelines, text data of the past cases, and a consultation content text of the user in a predetermined format, and generates input prompt data. This processing unit inputs this input prompt data to a transformer model equipped with a self-attention mechanism. This model executes a matrix operation for calculating relevance between respective elements of the input token sequence, and autoregressively generates a token sequence of a response text. This model generates specific response text data including submission requirements of the application form and past description examples as an output. Furthermore, an ambiguity determination module in this processing unit calculates a product of output probabilities of respective tokens of the generated response text, and calculates a certainty score of the entire response. When the certainty score falls below 0.7, which is a preset threshold, or when a target data type, which is an essential slot, is an empty value, this module executes a conditional branching process to an additional question generation mode. This module inputs a dedicated prompt for generating an additional question to a language model, and acquires text data of the additional question as an output. This processing unit transmits this additional question text data to the terminal. When the user inputs an additional information text from the terminal, this processing unit combines the held context data and the additional information text, inputs them to the language model again, and executes an inference process. By such dynamic dialogue flow control based on probabilistic evaluation, the present system realizes an optimal information extraction process according to a situation of the user, rather than one-sided information provision. As a result, the present system exhibits a technical effect of providing a highly accurate response completely matching business requirements, and preventing occurrence of a security incident.

This series of exchanges is entirely recorded in chronological order by a log management unit, and can be utilized by an administrator later to analyze consultation trends, revise guidelines, or automatically generate FAQs through an administrator interface unit. Furthermore, a security control unit also has a function of, when confidential information or personal information is included in the consultation content or the response content, automatically masking a corresponding part and hiding it when displayed in a log or on a management screen. Specifically, the log management unit of the server aggregates all text data transmitted and received in a series of dialogue sessions, extracted document IDs, and generated response data into a buffer on the memory. The log management unit formats these data as a log record in a JSON format. Before the log record is written to a storage, the security control unit of the server executes an interrupt process. The security control unit applies a named entity extraction model to the text data in the log record. This model divides the text data into a word token sequence, and outputs a probability distribution of BIO tags for each token. For example, this model determines that a probability of a tag indicating a personal name or a tag indicating a confidential project name is high for a specific character string. The security control unit detects a token whose probability exceeds a threshold, and specifies a memory address of the character string. The security control unit executes a memory rewriting process of replacing character string data on the specified memory address with a masking character such as an asterisk. After the masking process is completed, the log management unit applies an advanced encryption standard algorithm to the entire log record, and generates encrypted binary data. The log management unit writes this binary data to a non-volatile storage device. By incorporating such automatic masking and encryption processing at a system level, the present system physically and logically eliminates a risk of confidential information leakage when the administrator browses the log. As a result, the present system exhibits a technical effect of providing a secure log analysis environment while complying with strict data privacy regulations.

In this use case, specific examples of a prompt text to be read by the generative AI include “Please generate an optimal response text for the following consultation content by referring to internal regulations, guidelines, and past consultation cases. Consultation content: ‘I want to use generative AI for business, but what kind of procedure is necessary?’”, and “Please generate a guidance text asking a user for necessary additional information for the following consultation content. Consultation content: ‘I want to use AI’”. Furthermore, a prompt such as “When there are a plurality of related guidelines and past cases for the following consultation content, please evaluate relevance and importance, and generate a prioritized response text. Consultation content: ‘I want to outsource data analysis using AI, but what kind of security measures are necessary?’” can also be used. Specifically, the prompt text to be read by the generative AI in the present system functions as a system instruction code for directly controlling an inference process of a large language model. Prompt data is structured into three segments of a system role, a user role, and context data, and is arranged on the memory. Constraint conditions defining a behavior of the model are described in the system role segment. Text data of the internal regulations and past cases extracted by the information reference unit is inserted into the context data segment. A consultation content text of the user is arranged in the user role segment. When a prompt instructing prioritization is input, an attention layer inside the language model executes a matrix operation so as to assign a larger weight coefficient to a token indicating relevance or importance, which is a specified evaluation criterion. The language model calculates a probability distribution of output tokens based on this weighted feature amount representation. The language model generates structured text data in a bulleted format to which an importance score is assigned as an output. For example, the language model outputs text data in which a security measure having the highest importance is arranged at the top of a list, and an article number of a regulation serving as a basis is assigned to each item. By applying such a structured prompt engineering method, the present system deterministically controls an output of the large language model, which tends to be a black box, in accordance with specific business requirements. As a result, the present system exhibits a technical effect of mathematically guaranteeing consistency of a format and a content of a response, and improving readability and understanding of the user.

Also, for example, when an employee in a sales department consults “I want to take out a customer list with a USB memory, but what kind of procedure is necessary?”, the consultation reception unit receives this content, and the information reference unit searches for and extracts data taking-out regulations, personal information protection regulations, past taking-out application cases, and the like. The generative AI processing unit generates a response text such as “For taking out a customer list with a USB memory, it is necessary to submit an application form in advance and obtain approval from an information security department. A reason for taking out, a data type, a taking-out method, a taking-out destination, a scheduled return date, and the like should be described in the application form. In past application cases, submission of a data erasure certificate after taking out is also required.” When the consultation content is ambiguous, such as “I want to consult about data taking-out”, it automatically generates an additional question such as “Please tell me a data type of a taking-out target and a taking-out method (USB, cloud storage, mail attachment, etc.)”. Specifically, the consultation reception unit of the server receives character string data transmitted from the terminal operated by the employee in the sales department. The consultation reception unit generates a word embedding vector from the input text using a natural language processing engine. The consultation reception unit extracts characteristic vector components such as a USB memory and taking-out from the generated vector group. The information reference unit searches a vector database using these feature vectors as a query, and specifies document vectors of the data taking-out regulations and the personal information protection regulations having high cosine similarity. The information reference unit loads text data of the specified documents into the memory. The generative AI processing unit inputs the loaded text data and the consultation content to the language model. The language model extracts important entities such as prior application, approval, and a data erasure certificate from the regulation text. The language model connects these entities in a logical context, and outputs response text data explaining a specific procedure. Furthermore, an essential slot extraction module in the generative AI processing unit collates a parameter list required by the regulations with the input content. This module detects that values corresponding to slots of a data type and a taking-out method do not exist in the input data. This module executes a conditional branching process triggered by this detection signal, and activates an additional question generation module. This module generates text data prompting input of missing slots as an output, and transmits it to the terminal. By such cooperation between the vector search and a slot filling algorithm, the present system universally responds to various consultation scenarios. As a result, the present system exhibits a technical effect of eliminating a need for individual rule-based programming, and dramatically improving expandability and maintainability of the system.

In this way, the system of the present invention consistently executes category classification, related information search, optimal response generation, additional information request, history management, and security control automatically using generative AI for a consultation content input by a user, and realizes various effects such as efficiency improvement of information security consultation business, homogenization of response quality, reduction of business load, rapid response, improvement of a self-resolution rate, and analysis and feedback of consultation trends. Specifically, the system of the present invention executes an advanced data processing pipeline integrating a natural language processing model, a high-dimensional vector search engine, and a state machine control module on a memory and a processor of a server. The present system completely eliminates a conventional mental process in which a human visually searches a manual, understands contents, and drafts a response text. The present system replaces these processes with physical and mathematical arithmetic processing peculiar to a computer, such as tensor conversion of text data, inner product calculation in a high-dimensional vector space, matrix operation of attention weights, and token generation based on a probability distribution. The processor continuously executes these operations on the input text data with a latency in milliseconds. The processor immediately outputs optimal response text data and additional question text data obtained as an operation result via a network interface. At the same time, the processor encrypts input/output data of all operation processes and records them in a storage. By such close cooperative operation of hardware resources and an advanced AI algorithm, the present system realizes complete automation of the information security consultation business. As a result, the present system exhibits complex and remarkable technical effects of homogenization of response quality, dramatic reduction of business load, minimization of downtime by rapid response, and efficient use of computer resources.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

An embodiment of the present invention is a system for automating and sophisticating extremely diverse field operations such as failure response, operation procedures, security incident response, daily inspection, configuration change, emergency response, and outsourcing management at an operation site of a data center, and is composed of a server and a terminal. The terminal is an information processing apparatus such as a personal computer, a tablet, a smartphone, or a dedicated terminal operated by a person in charge of data center operation, an engineer, or an administrator, and the server has main functions such as a consultation reception unit, an information reference unit, a generative AI processing unit, a log management unit, an administrator interface unit, a user interface unit, a security control unit, and an external cooperation unit. The terminal provides a user interface for the person in charge of operation to input a consultation content regarding a failure or operation, and plays a role of transmitting the input consultation content to the server. For example, a text box “Please input failure contents or operational questions”, a “Transmit” button, a link for referring to a past consultation history, a shortcut to FAQs, a voice input button, a template selection function, an emergency call button, and the like are displayed on a screen of the terminal. Furthermore, on the terminal side, in preparation for a case where hands are tied during work at the site, various input means such as voice input, device identification by a barcode reader, site photo attachment by a camera, and site map linkage are provided. Specifically, at the operation site of the data center, an A/D converter inside the terminal converts an analog voice signal acquired by a microphone device, which is a voice input unit of the terminal, into digital voice data in a PCM format. A processing unit of the terminal transmits this digital voice data to the server. The consultation reception unit of the server inputs the received voice data to a voice recognition AI model. This model has a hybrid structure combining a convolutional neural network and a recurrent neural network. This model converts the voice data into a feature amount matrix of Mel-frequency cepstral coefficients, and decodes and outputs text character string data from this matrix. Also, the processing unit of the terminal transmits RGB image data of a field device acquired by a camera device of the terminal to the server. The consultation reception unit of the server inputs the received image data to an image recognition model. This model has a residual network architecture, and extracts and outputs a feature vector indicating a model number of the device or a lighting state of an error lamp from the image data. Furthermore, position information coordinate data acquired by a GPS sensor or a Wi-Fi module of the terminal is also transmitted to the server. The consultation reception unit of the server integrates the text data, the image feature vector, and the position information data, and constructs a multimodal input tensor on the memory. By such cooperation between various sensor devices and a multimodal AI model, the present system collects accurate situation data even in a field environment where keyboard input is difficult. As a result, the present system exhibits a technical effect of realizing efficiency improvement of field work by hands-free input, and contributing to accurate grasping of a failure situation and speeding up of initial response.

On the server side, first, the consultation reception unit receives the consultation content received from the terminal, and records this together with metadata such as a time, user identification information, terminal information, a failure type, an impact range, and a consultation category (storage failure, network failure, backup failure, access authority management, security incident, power failure, air conditioning abnormality, fire alarm, outsourcing work, configuration change application, etc.). For example, when the person in charge of operation inputs “A storage failure has occurred. Please tell me a response procedure”, the consultation reception unit receives this content, automatically issues a consultation ID, and stores the consultation content, the time, the user information, a rack number and a device ID at the site, a failure occurrence time, an impact server list, a site photo, and the like together in a database. At the time of receiving the consultation content, when there is a defect or a typographical error in the input content, a correction candidate is automatically presented, or when category classification is ambiguous, the generative AI automatically performs category estimation. For example, it also responds to various expressions such as “Server does not respond”, “Network is slow”, “Backup failed”, “What is a lending procedure for administrator authority?”, “Air conditioning alarm is sounding”, and “Outsourcing contractor entered the building but work procedure is unknown”. Specifically, the consultation reception unit of the server inputs the constructed multimodal input tensor to an encoder network of the generative AI. This network fuses context information of text, a visual abnormality pattern extracted from an image, and rack position data based on position information in a high-dimensional space, and generates an integrated feature vector. The consultation reception unit inputs this integrated feature vector to a fully connected layer for a classification task. The fully connected layer outputs a probability distribution vector belonging to each failure category and a normalized score value indicating an urgency of the failure as an output. For example, the output data includes numerical values such as a probability of 0.92 for the storage failure category and a probability of 0.05 for the network failure category, and a numerical value of an urgency score of 0.85. The consultation reception unit writes a category having the maximum probability as metadata to a record of the database. At the same time, the consultation reception unit inputs the calculated urgency score to a comparator circuit or a comparison operation module on the memory. The comparison operation module determines whether or not the urgency score exceeds 0.8, which is a preset threshold. When the score exceeds the threshold, the consultation reception unit bypasses a normal processing queue, and executes a hardware interrupt process of immediately transmitting an alert packet to an administrator terminal. By applying such advanced inference and priority control algorithm based on multimodal data, the present system realizes deep situation understanding impossible with simple keyword matching. As a result, the present system exhibits a technical effect of enabling early discovery of a serious failure, and completely preventing a delay in initial response for minimizing system downtime.

Next, the information reference unit searches for information related to the consultation content from operation manuals, failure response procedure manuals, security guidelines, access authority management regulations, backup/restore procedure manuals, outsourcing operation regulations, configuration change application procedures, power/air conditioning/fire alarm response procedures, a past failure response case database, inspection records, outsourcing work reports, and the like stored in a storage device in the server. For example, keywords and contexts such as “storage failure”, “failure response”, “disconnection”, and “spare storage” are extracted, and manuals, past failure cases, security guidelines, related inspection records, and outsourcing work reports corresponding to these are searched at high speed. For a search algorithm, not only simple keyword matching but also semantic similarity determination using a natural language processing technology by generative AI is utilized. For example, semantic analysis by generative AI is utilized even when expressions are different, such as “Storage failure occurred”, “No response from storage”, “Error lamp of storage is lit”, “Firmware abnormality of storage”, and “Insufficient capacity warning of storage”. Furthermore, the information reference unit extracts only the latest and appropriate information in consideration of revision histories and expiration dates of manuals and guidelines, application ranges (overall application, specific rack limitation, specific model limitation, etc.), presence or absence of outsourcing work, recent inspection records, and failure trends. For example, failure cases that occurred in the past in the same model, failure trends in the same rack, recent work histories by an outsourcing contractor, and the like are also set as reference targets. Specifically, the information reference unit of the server holds a query vector generated from the input text data and image feature amounts on the memory. Using this query vector, the information reference unit executes a K-nearest neighbor algorithm on a high-dimensional vector space in which document vectors of manuals and past cases are stored. This algorithm rapidly specifies top K document vectors having a close Euclidean distance or cosine similarity to the query vector, and extracts corresponding unstructured text data. In parallel, the information reference unit sets a rack number specified from the device ID and position information extracted by the image recognition model as a search key. Using this search key, the information reference unit issues an SQL query to a relational database. A database management system executes this query, and extracts and outputs structured data including a recent inspection record and an outsourcing work history of the corresponding device. The information reference unit combines the unstructured text data obtained by the vector search and the structured data obtained by the SQL search on the memory, and generates an integrated context data set. By adopting a hybrid search architecture that executes such vector similarity search and relational database search in parallel, the present system seamlessly integrates static manual information and dynamically changing field history data. As a result, the present system exhibits a technical effect of realizing highly accurate information extraction completely adapted to the latest situation at the site, and eliminating a risk of a secondary failure due to presentation of an incorrect procedure.

The generative AI processing unit receives the manuals, past cases, guidelines, inspection records, and outsourcing work reports extracted by the information reference unit, and the consultation content of the user as inputs, and generates an optimal response text using a natural language processing model. For example, it automatically generates a specific response adapted to field practice based on contents of the manuals, past cases, inspection records, and outsourcing work histories, such as “When a storage failure occurs, first disconnect the corresponding storage and execute switching to a spare storage. After switching, confirm consistency of backup data, and execute a recovery procedure as necessary. Also, based on an incident response guide, immediately report a fact of failure occurrence to an administrator, and leave a failure record. Furthermore, according to a recent inspection record, since firmware update work has been executed within the past one month in the same storage, confirmation of a firmware version is also recommended.” The generative AI summarizes contents of the extracted manuals and cases, and converts them into appropriate expressions in accordance with the consultation content. For example, it also automatically performs article citation, case introduction, and field history linkage, such as “Based on Section 2 of a storage failure response procedure, perform switching to a spare storage after disconnecting a failed storage”, “In a past failure case, a data consistency check is executed after switching, and if there is no problem, it returns to normal operation”, and “Based on a work history by an outsourcing contractor, additionally execute an inspection item after work”. Specifically, the generative AI processing unit of the server embeds the integrated context data set generated by the information reference unit and consultation content text data of the user into a predetermined prompt template. This processing unit inputs the constructed prompt data to a large language model. The language model executes a matrix operation for calculating relevance between each token of the consultation content and each token of the context data using an internal cross-attention mechanism. The language model logically reconciles standard procedure text of the manual and device state data indicated by the recent inspection record. The language model autoregressively generates structured response text data including a character string of a specific recovery command, a directory path of a log file to be confirmed, and contact information of an escalation destination as an output. For example, the language model outputs character string data of an actual CLI command following a text “A disconnection command of the storage is as follows”. This processing unit transmits the generated response text data to the terminal, and displays it on a screen. By such an algorithm for dynamically integrating a plurality of information sources and generating a text, the present system eliminates a cognitive load for the person in charge of operation to compare a plurality of screens and materials. As a result, the present system exhibits a technical effect of automatically generating a specific action plan that can be immediately executed by a field engineer, and dramatically shortening a mean time to repair until failure recovery.

Furthermore, when the consultation content has ambiguity or missing information, the generative AI automatically determines that point, and also generates a guidance text prompting a person in charge of operation for additionally required information, such as “Please tell me a model number and a connection method of a storage in which a failure has occurred”, “Please specifically input a failure occurrence time and an impact range”, “Please attach a site photograph at the time of failure occurrence”, or “Please tell me presence or absence of outsourced work immediately before the failure occurrence”. For example, in response to an input “Network is slow”, an additional question such as “Please tell me a network section where a delay is occurring and an IP address of an affected server”, “Please input a delay occurrence time and a traffic status”, or “Please tell me presence or absence of a latest configuration change or outsourced work” is automatically generated. Furthermore, when the person in charge of operation inputs the additional information, a loop process of cooperating with the information reference unit again and generating an optimal response text is realized. Specifically, the generative AI processing unit of the server activates an internal verification module that evaluates executability of the generated response text data. This module reads a list of essential parameters necessary for failure identification defined in metadata of the extracted manual from a memory. The essential parameters include an IP address of a target server, a character string of an error code, a network segment indicating an impact range, and the like. This module applies regular expression matching and a named entity extraction algorithm to the input consultation content data set, and checks whether these parameter values exist. This module detects that any of the essential parameters is missing by a logical product operation. When the missing is detected, this module temporarily suspends output of the response text, and activates an additional question generation module. This module generates text data requesting input of the missing parameter. For example, this module outputs character string data “Please input the IP address of the target server”. Furthermore, this module generates control metadata for displaying a dedicated input form on a UI of the terminal together with this text data, and transmits the control metadata to the terminal. By state machine processing combining such strict parameter verification and dynamic UI control, the present system blocks output of a speculative operation instruction based on incomplete information at a system level. As a result, the present system exhibits a technical effect of mathematically ensuring safety in operation of a data center and preventing a fatal system failure due to an erroneous operation.

In addition, when a plurality of manuals, past cases, guidelines, inspection records, and outsourced work histories are applicable, the generative AI automatically evaluates relevance and importance of each, and generates a response text including prioritized information. For example, when all of a “storage failure response procedure”, a “backup recovery procedure”, an “incident response guide”, and an “outsourced work report” are applicable, a procedure having the highest relevance is preferentially presented along a flow of failure response, and a plurality of procedures, guidelines, and work histories are written together as necessary. Furthermore, when a plurality of past failure cases exist, the cases are presented in descending order of similarity, and past countermeasures and results for each case are also presented together, thereby increasing a possibility that the person in charge of operation can solve the problem by himself/herself. For example, knowledge useful in an actual site, such as a “case of switching to a standby storage when a storage failure occurs”, a “case of executing a data consistency check after switching”, a “case in which a recurrence prevention measure is strengthened because an incident report is neglected when a failure occurs”, and a “case in which a failure occurs after outsourced work”, is comprehensively presented. Specifically, the generative AI processing unit of the server applies a ranking algorithm based on machine learning to a data set of a plurality of procedure manuals and past cases extracted from the information reference unit. This processing unit constructs a feature vector for each document data. This feature vector includes, as elements, a cosine similarity score with a query vector, a time stamp value indicating a last update date and time of the document, an integer value indicating the number of past references, and a failure urgency score calculated by the consultation reception unit. This processing unit inputs this feature vector to a ranking model. The ranking model performs a linear or non-linear operation using an internal weight parameter, and outputs a comprehensive relevance score for each document as a real value. This processing unit executes an algorithm for sorting a document list on the memory in descending order based on the calculated relevance score. This processing unit extracts text data in order from the top of the sorted list, loads the text data into a context window of a language model, and uses the text data for generating the response text. For example, in the case of a failure with high urgency, this processing unit dynamically changes weighting so as to give a higher score to a procedure manual in which an immediate recovery command is described than to a detailed explanatory document. By executing dynamic scoring and sorting processing based on such a multidimensional feature, the present system preferentially arranges information with the highest value within a limited context window. As a result, the present system exhibits a technical effect of preventing a decrease in inference accuracy of the AI due to information overload and presenting the most effective solution at the fastest speed.

The log management unit records all consultation contents, response contents, additional questions, input histories from the person in charge of operation, manual reference histories, detailed logs of a response generation process by the AI, site photographs and voice records, outsourced work histories, inspection records, and the like in chronological order. For example, when a certain person in charge of operation consults “Backup failed”, the AI asks an additional question “Please tell me a type and a time of the failed backup”, the person in charge inputs “Full backup at 2 o'clock every day failed”, and a final response is “When full backup fails, confirm consistency of differential backup and re-execute as necessary”, all of these series of exchanges are recorded. The log management unit also includes search, aggregation, and analysis functions so that an administrator can analyze a failure tendency later or utilize it for manual revision or automatic FAQ generation. For example, when a specific failure frequently occurs, a function of automatically notifying the administrator and a function of automatically converting a common failure response into an FAQ can be implemented. Furthermore, the log management unit also considers confidentiality of the consultation content and personal information protection, and performs automatic anonymization and access control of the consultation content as necessary. For example, when a customer name, a project name, a confidential system name, or the like is included in the consultation content, the corresponding part is automatically masked and hidden when displayed on a log or an administrator screen. Specifically, the log management unit of the server aggregates all input/output data generated in a series of failure response sessions, extracted document IDs, generated response texts, and binary data of images and voices transmitted from the terminal. The log management unit serializes these data as a structured record in a JSON format, and asynchronously writes the structured record in a distributed storage system. Furthermore, an analysis processing unit of the server periodically executes a clustering algorithm as a background process. The analysis processing unit generates a vector representation from text data of accumulated log records, and groups the data by applying an algorithm such as a K-Means method on a high-dimensional space. The analysis processing unit specifies a cluster center vector of a frequently occurring failure pattern as an output, and automatically generates candidate text data of a new FAQ entry from a data group belonging to this cluster. In addition, an anonymization processing unit of the server detects confidential information such as an IP address, a host name, and a person in charge name in the text data using a regular expression engine before the log record is written in the storage. The anonymization processing unit applies a cryptographic hash function such as SHA-256 to the detected character string, and executes memory rewriting processing for converting the character string into an irreversible hash value character string. By integrating such advanced data mining and system-level encryption processing, the present system automatically converts knowledge obtained from daily operation work into a knowledge base. As a result, the present system exhibits a technical effect of continuously improving response capability of the entire organization and realizing safe data management strictly complying with security compliance.

The administrator interface unit provides a dedicated screen for a system administrator or a data center operation manager to perform update of a manual or a past case database, tuning of an AI model, analysis of a failure tendency, monitoring of a usage status, access authority management, management of an outsourced work history, reference to an inspection record, emergency notification at the time of failure occurrence, automatic FAQ generation, quality evaluation of an AI response content, blacklisting of a specific consultation content, access control for each person in charge of operation, and the like. The administrator interface unit also includes statistical analysis of consultation contents and response contents, dashboard display, graphing of failure tendencies, feedback input for improving AI response accuracy, automatic determination of a risk level of a consultation content, an escalation function according to urgency, contact history management with an outsourcer, automatic aggregation of inspection records, and the like. Specifically, the administrator interface unit receives an operation input from the system administrator. The administrator interface unit analyzes the input operation command. The administrator interface unit adjusts a hyperparameter of a large language model based on an analysis result. The administrator interface unit updates numerical values such as a learning rate and a batch size. The administrator interface unit activates a re-learning process using the updated parameter. The administrator interface unit prepares learning data for tuning. The administrator interface unit inputs the learning data to a natural language processing model. Input data to the natural language processing model is a one-dimensional array of integers obtained by tokenizing and digitizing text. The number of dimensions of the input data is a maximum of 512 dimensions. An element content of the input data is a vocabulary ID corresponding to each word or subword. The administrator interface unit executes text normalization and stop word removal as preprocessing. As a specific example of the input data, a first is an array “105, 342, 890” obtained by converting text “forgot password”. A second is an array “45, 992, 12” obtained by converting text “server does not start”. A third is an array “77, 234, 56” obtained by converting text “network is slow”. The natural language processing model processes the input array. The natural language processing model generates a probability distribution belonging to each category as output data. A format of the output data is a one-dimensional vector of floating-point numbers having the number of dimensions equal to the number of categories. Each value of the output data means a probability that the input text belongs to the corresponding category. As a specific example of the output data, a first is a score “0.95” for an account management category. A second is a score “0.88” for a hardware failure category. A third is a score “0.92” for a network failure category. The administrator interface unit passes the output probability distribution to subsequent processing. The administrator interface unit selects a category with the highest probability as a prediction label in the subsequent processing. The administrator interface unit calculates a cross entropy error between the prediction label and a correct label. The administrator interface unit executes an error backpropagation method based on the calculated error. The administrator interface unit updates a weight parameter of the model. The administrator interface unit acquires past failure history data from a time-series database. The administrator interface unit converts the acquired time-series data into a multidimensional tensor. The administrator interface unit inputs the converted tensor to a neural network for abnormality detection. The neural network extracts a feature amount from the input tensor. The neural network outputs a probability score of failure occurrence based on the extracted feature amount. The administrator interface unit compares the output probability score with a threshold value. The administrator interface unit generates a warning flag when the probability score exceeds the threshold value. The administrator interface unit generates a dashboard screen including the warning flag. The administrator interface unit transmits the generated screen to a terminal of the administrator. Thereby, the present system discovers a sign of a failure at an early stage. The present system dramatically improves operation efficiency of the data center. The present system overcomes a limit of visual monitoring by a human. The present system realizes proactive failure response. As a specific application field, the present system is applied to integrated monitoring work of a large-scale data center. The present system is used for operation automation of a cloud infrastructure.

The user interface unit provides a screen and an operation procedure for the person in charge of operation to input a consultation content from the terminal and receive and display a response from the server. For example, a text box “Please input failure content”, a “Send” button, a link for referring to a past consultation history, a shortcut to an FAQ, a copy/save/print function of a response content, an immediate response function to an additional question, support for voice input and voice output, an accessibility function, a site photograph attachment function, barcode reader cooperation, site map display, an emergency notification button, and the like are implemented on a screen of the terminal. The user interface unit also provides input assistance, automatic completion, template selection, automatic summarization of input content, multilingual support for input content, hands-free operation during site work, and the like according to an attribute and a past usage history of the person in charge of operation. Specifically, the user interface unit acquires multimodal data from an input device of the terminal. The user interface unit preprocesses the acquired text data, voice waveform data, and image pixel data, respectively. The user interface unit converts the voice waveform data into a mel-frequency cepstrum coefficient. The user interface unit normalizes the image pixel data and converts the image pixel data into a three-dimensional image tensor. The user interface unit transmits the preprocessed data to the server. The server inputs the received data to various artificial intelligence models. Input data to the artificial intelligence model is, for example, in the case of an image recognition model, a three-dimensional tensor of floating-point numbers having a width of 224 pixels, a height of 224 pixels, and 3 color channels. The number of dimensions of the input data is 224 times 224 times 3. An element content of the input data is a numerical value in a range of 0 to 1 indicating a luminance value of each pixel. The server executes image resizing and center cropping as preprocessing. As a specific example of the input data, a first is an image tensor obtained by photographing a red error lamp of a server rack. A second is an image tensor obtained by photographing a disconnected network cable. A third is an image tensor obtained by photographing a console screen on which an error message is displayed. The image recognition model processes the input image tensor by a convolutional neural network. The image recognition model generates a class label and a certainty score of an object shown in an image as output data. A format of the output data is a probability distribution vector having the number of dimensions equal to the number of classes. Each value of the output data means a probability that the image indicates a specific failure state. As a specific example of the output data, a first is a label indicating “power supply unit failure” and a score “0.98”. A second is a label indicating “cable disconnection” and a score “0.85”. A third is a label indicating “disk failure” and a score “0.91”. The server passes the output label and score to subsequent processing. The server automatically generates a search query for a corresponding failure response manual when the score exceeds a predetermined threshold value in the subsequent processing. The user interface unit uses an autoregressive language model as an input assistance function. The language model analyzes a context of text being input by a user. The language model predicts a word having a high possibility of appearing next. The user interface unit suggest-displays the predicted word on the screen. Thereby, the present system significantly reduces an input load on a site worker. The present system improves quality and uniformity of input data. The present system realizes an intuitive operation using voice and an image. The present system enhances convenience in a site environment where a keyboard operation is difficult. As a specific application field, the present system is applied to hands-free maintenance and inspection work using smart glasses. The present system is used for a voice dialogue system in a noisy server room.

The security control unit performs communication encryption, access authority management, login authentication, data masking/anonymization, authority control at the time of saving/referring to a consultation content, confidential information detection by AI, a security check at the time of external system cooperation, access control of an outsourcer, temporary expansion of access authority in an emergency, acquisition of an audit log, unauthorized access detection, and the like in order to ensure information security of the entire system. For example, a secure protocol such as HTTPS is used for communication between the server and the terminal, an accessible manual and consultation history are limited for each person in charge of operation, and acquisition of an audit log and unauthorized access detection by the administrator are also implemented. The security control unit is also responsible for automatic classification and risk level determination of a consultation content by AI, automatic notification to the administrator according to urgency, a security check at the time of data cooperation with an outsourcee, temporary expansion of access authority and automatic recovery at the time of failure occurrence, and the like. Specifically, the security control unit monitors all data packets transmitted from the terminal. The security control unit evaluates a dynamic access control list based on a zero trust architecture. The security control unit verifies an authentication token of a user. The security control unit uses a named entity extraction model in order to detect confidential information included in the input text data. Input data to the named entity extraction model is an embedding vector of a token sequence obtained by dividing text into word units. The number of dimensions of the input data is, for example, 768 dimensions. An element content of the input data is a floating-point number expressing a semantic feature of each token. The security control unit removes a special symbol from the text and executes lowercasing as preprocessing. As a specific example of the input data, a first is a vector representation of text “data of customer Mr. Yamada”. A second is a vector representation of text “design document of project X”. A third is a vector representation of text “IP address 192.168.1.1”. The named entity extraction model processes the input vector sequence by a bidirectional recurrent neural network. The named entity extraction model generates a named entity tag for each token as output data. A format of the output data is a sequence of category labels based on BIO notation. Each value of the output data means whether the token corresponds to personal information or confidential information. As a specific example of the output data, a first is a label “personal name” for “Yamada”. A second is a label “confidential project” for “project X”. A third is a label “internal IP” for “192.168.1.1”. The security control unit passes the output tag sequence to subsequent processing. The security control unit executes masking processing for replacing a token determined as confidential information with a hidden character such as an asterisk in the subsequent processing. The security control unit saves only the masked safe text data in a log database. The security control unit executes an abnormality detection algorithm in order to analyze behavior of network traffic. The security control unit maps a feature amount such as a transmission source IP, a port number, and a packet size of communication to a multidimensional space. The security control unit specifies a data point deviating from a normal communication pattern using an isolation forest algorithm. The security control unit blocks communication when an abnormality score exceeds a threshold value. Thereby, the present system prevents information leakage due to internal fraud or an external cyber attack. The present system guarantees safe handling of confidential data. The present system maintains a robust audit trail satisfying a compliance requirement. The present system reduces an operation load on a security administrator. As a specific application field, the present system is applied to strict access management in a data center of a financial institution. The present system is used for protection of a cloud environment handling confidential information of a government agency.

The external cooperation unit cooperates with a monitoring system, a configuration management system, an entry/exit management system, an outsourcer management system, a cloud service, an API cooperation destination, and the like in the data center, and realizes automatic detection at the time of failure occurrence, automatic acquisition of a configuration change history, automatic recording of outsourced work, automatic cooperation of a monitoring alert, automatic data acquisition from an external system, automatic notification in an emergency, and the like. For example, when a storage failure alert is automatically transmitted from the monitoring system, the consultation reception unit can automatically receive a failure content, and immediately execute automatic countermeasure presentation by AI. Specifically, the external cooperation unit periodically executes polling communication to a plurality of external systems. The external cooperation unit acquires structured data in a JSON format or an XML format from the external system. The external cooperation unit parses and converts the acquired data into an internal common data schema. The external cooperation unit stores the converted data in a time-series database. The external cooperation unit uses a time-series prediction model in order to analyze alert data received from the monitoring system. Input data to the time-series prediction model is a multivariate time-series matrix including a CPU usage rate, a memory usage amount, a network traffic amount, and the like for a certain past period. The number of dimensions of the input data is, for example, 60 time steps times 10 feature amounts. An element content of the input data is a floating-point number indicating a measured value of a system resource at each time. The external cooperation unit executes interpolation of a missing value and standardization of data as preprocessing. As a specific example of the input data, a first is transition data of a CPU usage rate of a web server for the past one hour. A second is transition data of disk IOPS of a database server. A third is transition data of the number of requests per second of a load balancer. The time-series prediction model processes the input matrix by a long short-term memory network. The time-series prediction model generates a predicted value of a resource usage amount and an abnormality occurrence probability at a specific future time as output data. A format of the output data is a continuous value of the predicted value and a probability value in a range of 0 to 1. Each value of the output data means a risk that the system will fall into an overload state in the future. As a specific example of the output data, a first is a predicted value of a CPU usage rate “95 percent” after 10 minutes. A second is a score of an occurrence probability of memory exhaustion “0.85”. A third is a score of a saturation probability of a network bandwidth “0.90”. The external cooperation unit passes the output predicted value and probability to subsequent processing. The external cooperation unit generates a proactive alert when the probability exceeds a threshold value in the subsequent processing. The external cooperation unit transfers the generated alert to the consultation reception unit. The external cooperation unit calls an API of the configuration management system, and acquires a dependency relationship graph of a device in which a failure has occurred. The external cooperation unit inputs the dependency relationship graph to a graph neural network, and specifies an impact range. Thereby, the present system integrates siloed operation tool groups. The present system automates root cause analysis of an incident. The present system minimizes a lead time from failure occurrence to start of response. The present system dramatically improves visibility of the entire system. As a specific application field, the present system is applied to integrated orchestration in a multi-cloud environment. The present system is used for distributed tracing of a large-scale microservice architecture.

As described above, the embodiment of the present invention realizes a wide range of effects such as efficiency improvement of failure response work at a data center operation site, uniformization of response quality, reduction of a work load, prompt response, improvement of a self-resolution rate, analysis and feedback of a failure tendency, improvement of safety of site work, strictness of outsourcing management, promptness of emergency response, and enhancement of audit response by comprehensively utilizing operation manuals, failure response procedure manuals, security guidelines, past failure cases, inspection records, outsourced work histories, site photographs, monitoring alerts, configuration management information, and the like with generative AI as a core, and automatically generating an optimal countermeasure and an additional question according to a consultation content of a person in charge of operation. For example, for various events that can occur at a site, such as a storage failure, a network delay, a backup failure, unauthorized use of access authority, detection of suspicious access from the outside, a power failure, an air conditioning abnormality, a fire alarm, an outsourced work mistake, a configuration change application mistake, and a monitoring alert false alarm, the generative AI comprehensively utilizes past knowledge, regulations, site histories, and external cooperation information, thereby realizing a new operation support system capable of allowing a person in charge of the site to immediately grasp an optimal countermeasure. Furthermore, advanced functions extremely useful for both an administrator and a site, such as multilingual support for failure contents, an accessibility function for a person with a disability, support for voice input and voice output, chatbot and mail cooperation, API cooperation with an external system, automatic analysis of a site photograph and a moving image, automatic analysis of a failure tendency by AI, automatic determination of a risk level, an escalation function according to urgency, statistical analysis and dashboard display of failure contents, and safety management support for site work, can also be implemented. Specifically, the present system adopts an ensemble architecture combining a transformer-based large language model and a convolutional neural network in order to integrally process multimodal information. The present system projects heterogeneous data such as text, an image, voice, and time-series data onto a common high-dimensional vector space. The present system calculates relevance of information at a speed and comprehensiveness impossible for a human by a vector operation in the high-dimensional space. The present system inputs an integrated feature vector to a situation recognition model. Input data to the situation recognition model is a one-dimensional tensor obtained by combining an embedding vector of text, a feature map vector of an image, and a hidden state vector of time-series data. The number of dimensions of the input data is, for example, 2048 dimensions. An element content of the input data is a latent variable expressing a complex situation of a site. The present system normalizes a vector of each modality and executes dimensionality reduction as preprocessing. As a specific example of the input data, a first is a vector obtained by combining voice text “abnormal noise is heard from server”, an image of a red lamp, and time-series data of a CPU temperature rise. A second is a vector obtained by combining text “network is not connected”, a port image of a router, and data of a packet loss rate. A third is a vector obtained by combining text “power is turned off”, an image of a completely dark rack, and data of a voltage drop. The situation recognition model processes the input combined vector by a multilayer perceptron. The situation recognition model generates an identifier and an execution priority of an optimal response action as output data. A format of the output data is an integer value of an action ID and a priority score in a range of 0 to 1. Each value of the output data means a specific operation procedure recommended by the system and its urgency. As a specific example of the output data, a first is an ID indicating “execution of failover to standby system” and a score “0.99”. A second is an ID indicating “restart of corresponding port” and a score “0.75”. A third is an ID indicating “operation confirmation of uninterruptible power supply” and a score “0.95”. The present system passes the output action ID and score to subsequent processing. The present system extracts a procedure manual corresponding to an action having the highest score from a database in the subsequent processing, and constructs a response text for a user using a natural language generation model. Thereby, the present system standardizes operation work depending on personal knowledge. The present system supports even an inexperienced operator to make an accurate judgment equivalent to that of an expert. The present system minimizes a downtime and complies with a service level agreement. The present system improves adaptive capability to an unknown failure pattern by continuous machine learning. As a specific application field, the present system is applied to 24-hour 365 -day non-stop operation of a mission-critical social infrastructure. The present system is used for core network monitoring work of a communication carrier.

### System Configuration

The system according to the present embodiment includes a consultation reception unit, an information reference unit, a generative AI processing unit, a log management unit, an administrator interface unit, a user interface unit, a security control unit, and an external cooperation unit. The consultation reception unit receives a consultation content regarding failure occurrence, an operation procedure, a security incident, daily inspection, a configuration change, outsourcing management, and the like transmitted from a personal computer, a tablet, a smartphone, a dedicated terminal, and the like operated by a person in charge of data center operation, an engineer, and an administrator, and records the received content together with various metadata such as a time, user identification information, terminal information, a failure type, an impact range, a consultation category, a site photograph, a voice record, site map information, and barcode information. For example, when a person in charge of a site utters “Storage failure occurred. Please tell me response procedure” by voice input at the time of storage failure occurrence, the consultation reception unit converts voice data into text, and also records a site photograph and a device ID read by a barcode together. Furthermore, the consultation reception unit automatically presents a correction candidate when there is a defect or a typographical error in an input content, and automatically performs category estimation using generative AI when category classification is ambiguous. For example, the consultation reception unit supports various expressions such as “Server does not respond”, “Network is slow”, “Air conditioning alarm is sounding”, and “Outsourcer entered building but work procedure is unknown”, and integrally manages a site photograph, a voice record, and site map information. Specifically, the consultation reception unit receives a data stream from the terminal by asynchronous communication. The consultation reception unit inputs the received voice data to a voice recognition model. Input data to the voice recognition model is a two-dimensional tensor of a mel spectrogram obtained by performing short-time Fourier transform on a voice waveform. The number of dimensions of the input data is, for example, 80 frequency bins times 500 time frames. An element content of the input data is a logarithmic value indicating power of voice at each time and frequency. The consultation reception unit executes removal of background noise and normalization of a volume as preprocessing. As a specific example of the input data, a first is a spectrogram of an utterance “lamp of storage is blinking red”. A second is a spectrogram of an utterance “temperature of rack is abnormally high”. A third is a spectrogram of an utterance “backup job failed”. The voice recognition model processes the input tensor by a network combining a convolutional layer and a recurrent layer. The voice recognition model generates a recognized text character string and a reliability score of each character as output data. A format of the output data is a sequence of character codes and an array of floating-point numbers in a range of 0 to 1. Each value of the output data means accuracy of a character predicted by the model. As a specific example of the output data, a first is a character string “storage failure” and an average score “0.96”. A second is a character string “network delay” and an average score “0.92”. A third is a character string “power loss” and an average score “0.98”. The consultation reception unit passes the output text character string to subsequent processing. The consultation reception unit inputs the text character string to a natural language processing model in the subsequent processing, and estimates a consultation category. The consultation reception unit tokenizes the text character string, and calculates a context vector using a self-attention mechanism. The consultation reception unit inputs the context vector to a fully connected layer, applies a softmax function, and calculates a probability distribution for each category. The consultation reception unit gives a category with the highest probability as metadata. The consultation reception unit structures all extracted metadata and saves the structured metadata in a relational database. Thereby, the present system absorbs fluctuation and noise of input data, and improves accuracy of subsequent search processing. The present system centrally manages multimodal information, and increases resolution of situation grasping. The present system saves time and effort of manual data input, and reduces a burden on a site worker. As a specific application field, the present system is applied to a mobile support tool for a maintenance worker patrolling in a vast data center. The present system is used for an emergency situation reporting system at the time of disaster occurrence.

The information reference unit searches for information related to the consultation content from operation manuals, failure response procedure manuals, security guidelines, access authority management regulations, backup/restore procedure manuals, outsourcing operation regulations, configuration change application procedures, power/air conditioning/fire alarm response procedures, a past failure response case database, inspection records, outsourcing work reports, monitoring alert histories, an on-site photo database, and the like stored in the storage device in the server. For example, keywords and contexts such as “storage failure”, “failure response”, “disconnection”, and “spare storage” are extracted, and corresponding manuals, past failure cases, security guidelines, related inspection records, outsourcing work reports, and monitoring alert histories are searched at high speed. The information reference unit utilizes not only simple keyword matching but also semantic similarity determination using natural language processing technology by generative AI, and utilizes semantic analysis even when expressions are different, such as “a storage failure has occurred”, “there is no response from the storage”, “an error lamp of the storage is lit”, “a firmware abnormality of the storage”, and “a capacity shortage warning of the storage”. Furthermore, the information reference unit also considers revision histories, expiration dates, and application ranges (overall application, specific rack limitation, specific model limitation, etc.) of the manuals and guidelines, presence or absence of outsourcing work, latest inspection records and failure trends, and monitoring alert histories, and extracts only the latest and appropriate information. For example, failure cases that occurred in the past in the same model, failure trends in the same rack, latest work histories by outsourcing contractors, latest alerts from the monitoring system, and the like are also set as reference targets. Specifically, the information reference unit executes an approximate nearest neighbor search using a vector database. The information reference unit inputs the text of the consultation content to an embedding model. Input data to the embedding model is a one-dimensional array of integers obtained by tokenizing the consultation content. The number of dimensions of the input data is a maximum of 512 dimensions. Element contents of the input data are vocabulary IDs of respective words. The information reference unit executes deletion of unnecessary symbols and stemming as preprocessing. As a specific example of the input data, the first is a token array of a text “there is no response from the storage”. The second is a token array of a text “reading and writing of the disk are slow”. The third is a token array of a text “LUN cannot be seen”. The embedding model processes the input array with a transformer encoder. The embedding model generates a dense vector expressing the meaning of the text as output data. A format of the output data is, for example, a 768-dimensional one-dimensional vector of floating-point numbers. Each value of the output data means a coordinate position of the text in a multidimensional semantic space. As a specific example of the output data, the first is a vector located in a conceptual space of storage failure. The second is a vector located in a conceptual space of performance degradation. The third is a vector located in a conceptual space of setting error. The information reference unit passes the output dense vector to subsequent processing. The information reference unit calculates a cosine similarity with a document vector group in the vector database in the subsequent processing. The information reference unit extracts top N documents having high cosine similarities as candidates. The information reference unit combines a score of a keyword search using a BM25 algorithm with the extracted candidates. The information reference unit calculates a final ranking score using a reciprocal rank fusion algorithm. The information reference unit applies a filtering condition of metadata, and excludes expired manuals and cases of unrelated models. Thereby, the system absorbs orthographical variants and differences in synonyms, and prevents search omissions. The system specifies related information in units of milliseconds from a huge document group. The system realizes highly accurate information search in line with the context. The system guarantees to always present the latest and appropriate procedure. As a specific application field, the system is applied to an enterprise knowledge base that manages technical documents extending to tens of thousands of pages. The system is used for a help desk system that cross-searches past incident tickets.

The generative AI processing unit receives the manuals, the past cases, the guidelines, the inspection records, the outsourcing work reports, and the monitoring alert histories extracted by the information reference unit, and the consultation content of the user as inputs, and generates an optimal response text using a natural language processing model. For example, a specific response in line with on-site practice based on contents of the manuals, the past cases, the inspection records, the outsourcing work histories, and the monitoring alert histories is automatically generated, such as “When a storage failure occurs, first disconnect the corresponding storage and execute switching to a spare storage. After the switching, confirm consistency of backup data, and execute a recovery procedure as necessary. Also, based on an incident response guide, immediately report the fact of the failure occurrence to an administrator, and leave a failure record. Furthermore, according to the latest inspection records, since firmware update work has been executed within the past one month in the same storage, confirmation of a firmware version is also recommended.” The generative AI processing unit summarizes contents of the extracted manuals and cases, and converts them into appropriate expressions in accordance with the consultation content. For example, article citation, case introduction, and on-site history linkage are also automatically performed, such as “Based on Section 2 of the storage failure response procedure, perform switching to the spare storage after disconnecting the failed storage”,

“In past failure cases, a data consistency check is executed after switching, and if there is no problem, normal operation is restored”, “Based on the work history by the outsourcing contractor, additionally execute inspection items after the work”, and “Based on the monitoring alert history, confirm presence or absence of other alerts in the same time zone”. Furthermore, when the consultation content has ambiguity or missing information, the generative AI processing unit automatically determines that point, and also generates a guidance text prompting a person in charge of operation for additionally required information, such as “Please tell me a model number and a connection method of the storage where the failure occurred”,

“Please specifically input a failure occurrence time and an impact range”, “Please attach an on-site photo at the time of the failure occurrence”, “Please tell me presence or absence of outsourcing work immediately before the failure occurrence”, and “Please input an ID of the monitoring alert”. Furthermore, when the person in charge of operation inputs the additional information, a loop process of cooperating with the information reference unit again and generating the optimal response text is realized. When a plurality of manuals, past cases, guidelines, inspection records, outsourcing work histories, and monitoring alert histories correspond, the generative AI processing unit automatically evaluates relevance and importance of each, and generates a response text including prioritized information. For example, when all of “storage failure response procedure”, “backup recovery procedure”, “incident response guide”, “outsourcing work report”, and “monitoring alert history” correspond, a procedure having the highest relevance is preferentially presented along a flow of the failure response, and a plurality of procedures, guidelines, work histories, and alert histories are written together as necessary.

The generative AI processing unit also analyzes on-site photos, voice records, and on-site map information, and also supports automatic determination of a failure situation and grasping of an on-site situation using image recognition and voice recognition. Specifically, the generative AI processing unit adopts a retrieval-augmented generation architecture. The generative AI processing unit constructs a prompt by combining the extracted document group and the consultation content of the user. The generative AI processing unit inputs the constructed prompt to a large language model. Input data to the large language model is a one-dimensional array of a token sequence in which a system prompt, context information, and a user input are concatenated. The number of dimensions of the input data is a maximum of 8192 dimensions. Element contents of the input data are vocabulary IDs of respective words and subwords. The generative AI processing unit limits a length of the context information and truncates sentences with low importance as preprocessing. As a specific example of the input data, the first is a token array in which the consultation content of the storage failure and the text of the response manual are combined. The second is a token array in which the consultation content of the network delay and the text of the past similar ticket are combined. The third is a token array in which the consultation content of the power supply abnormality and the text of the latest inspection record are combined. The large language model processes the input array with a decoder network provided with a self-attention mechanism. The large language model generates a probability distribution of a token to be generated next step by step as output data. A format of the output data is a sequence of probability vectors having the number of dimensions equal to a vocabulary size. Each value of the output data means a likelihood that a specific word appears next. As a specific example of the output data, the first is a probability “0.85” of a word “first”. The second is a probability “0.90” of a word “corresponding”. The third is a probability “0.95” of a word “storage”. The generative AI processing unit passes the output probability distribution to subsequent processing. The generative AI processing unit searches for an optimal token sequence using a beam search algorithm in the subsequent processing, and generates a final response text. The generative AI processing unit determines missing of essential information using a dialogue state tracking model. When a missing slot exists, the generative AI processing unit generates a question sentence for filling the slot. Thereby, the system suppresses hallucination not based on facts, and generates an accurate response. The system logically integrates a plurality of information sources, and presents a consistent procedure. The system automatically satisfies conditions necessary for problem solving through interactive information collection. The system dramatically improves a self-resolution rate of an on-site person in charge. As a specific application field, the system is applied to an intelligent assistant that supports complex troubleshooting. The system is used for a response suggestion system for operators in a call center.

The log management unit records all consultation contents, response contents, additional questions, input histories from the person in charge of operation, manual reference histories, detailed logs of a response generation process by AI, on-site photos and voice records, outsourcing work histories, inspection records, monitoring alert histories, and the like in chronological order. For example, when a certain person in charge of operation consults “backup failed”, the AI additionally asks “Please tell me a type and a time of the failed backup”, the person in charge inputs “full backup at 2 o'clock every day failed”, and a final response becomes “When the full backup fails, confirm consistency of a differential backup, and re-execute it as necessary”, all of these series of exchanges are recorded. The log management unit is also provided with search, aggregation, and analysis functions so that the administrator can analyze failure trends later, and utilize them for revision of manuals and automatic generation of FAQs. For example, when a specific failure frequently occurs, a function of automatically notifying the administrator, a function of automatically converting a common failure response into an FAQ, automatic classification of on-site photos and voice records, automatic aggregation of outsourcing work histories, automatic analysis of monitoring alert histories, and the like can also be implemented. Furthermore, the log management unit also considers confidentiality of the consultation content and personal information protection, and also performs automatic anonymization and access control of the consultation content as necessary. For example, when a customer name, a project name, a confidential system name, or the like is included in the consultation content, the corresponding part is automatically masked, and is hidden at the time of display on a log or an administrator screen. Specifically, the log management unit constructs a data lake that integrally manages unstructured data and structured data. The log management unit serializes text data and metadata into a JSON format. The log management unit asynchronously writes the serialized data to a distributed document-oriented database. The log management unit utilizes a token classification model for automatic anonymization processing. Input data to the token classification model is an embedding vector of a token sequence obtained by dividing a log text into word units. The number of dimensions of the input data is, for example, 768 dimensions. Element contents of the input data are floating-point numbers expressing semantic features of respective tokens. The log management unit executes normalization of text and removal of special characters as preprocessing. As a specific example of the input data, the first is a vector representation of a text “backup of company A system”. The second is a vector representation of a text “work record of person in charge Suzuki”. The third is a vector representation of a text “password is Pass123”. The token classification model processes the input vector sequence with a transformer encoder. The token classification model generates a confidential category label for each token as output data. A format of the output data is an integer array of category IDs. Each value of the output data means whether the token corresponds to personal information or confidential information. As a specific example of the output data, the first is a label “customer name” for “company A”. The second is a label “personal name” for “Suzuki”. The third is a label “authentication information” for “Pass123”. The log management unit passes the output label array to subsequent processing. The log management unit replaces the token corresponding to the confidential category with a hash or a masked character in the subsequent processing. The log management unit stores the safe text after the replacement in a persistent storage. The log management unit format-converts the accumulated log data as a data set for a reward model for reinforcement learning from human feedback. Thereby, the system achieves both reliable preservation of an audit trail and privacy protection. The system automatically constructs a high-quality corpus for continuous model learning. The system provides a foundation for data-driven operation improvement. The system minimizes a risk of compliance violation. As a specific application field, the system is applied to system operation log management of a medical institution where strict data governance is required. The system is used for a data pipeline for fine-tuning of a large language model.

The administrator interface unit provides a dedicated screen for a system administrator or a person responsible for data center operation to perform updating of manuals and the past case database, tuning of an AI model, analysis of failure trends, monitoring of a usage status, access authority management, management of outsourcing work histories, reference to inspection records, emergency notification at the time of failure occurrence, automatic generation of FAQs, quality evaluation of AI response contents, blacklisting of specific consultation contents, access control for each person in charge of operation, management of monitoring alert histories, management of on-site photos and voice records, and the like. The administrator interface unit is also provided with statistical analysis of consultation contents and response contents, dashboard display, graphing of failure trends, feedback input for improving response accuracy of AI, automatic determination of a risk level of the consultation content, an escalation function according to a degree of urgency, contact history management with outsourcing contractors, automatic aggregation of inspection records, automatic analysis of monitoring alert histories, automatic classification of on-site photos and voice records, and the like. Specifically, the administrator interface unit generates a real-time dashboard in cooperation with a backend aggregation engine. The administrator interface unit issues a complex aggregation query to a time-series database. The administrator interface unit binds the acquired aggregation result to a visualization component. The administrator interface unit utilizes a clustering algorithm for automatic analysis of failure trends. Input data to the clustering algorithm is a feature vector group extracted from past consultation content texts. The number of dimensions of the input data is, for example, the number of data points 10000 times the number of feature dimensions 256. Element contents of the input data are floating-point numbers indicating semantic features of respective consultation contents. The administrator interface unit executes dimension reduction by principal component analysis as preprocessing. As a specific example of the input data, the first is a vector matrix of a network-related consultation group. The second is a vector matrix of a hardware failure-related consultation group. The third is a vector matrix of a software setting-related consultation group. The clustering algorithm processes the input vector group using a K-means method or DBSCAN. The clustering algorithm generates a cluster ID to which each data point belongs and center coordinates of the cluster as output data. A format of the output data is an array of integer values and a matrix of floating-point numbers. Each value of the output data means grouping of similar failure events. As a specific example of the output data, the first is grouping of “cluster 1 (router setting mistake)”. The second is grouping of “cluster 2 (disk capacity shortage)”. The third is grouping of “cluster 3 (authentication error)”. The administrator interface unit passes the output cluster information to subsequent processing. The administrator interface unit extracts a representative keyword of each cluster in the subsequent processing, and generates a trend graph of frequent failures. When a rapidly increasing cluster is detected, the administrator interface unit displays a pop-up warning on the screen of the administrator. Thereby, the system enables the administrator to intuitively grasp soundness of the entire system. The system discovers a cause of a potential failure at an early stage, and enables a proactive countermeasure. The system supports optimal allocation of operation resources. The system provides an interface for running a continuous improvement cycle of the AI model. As a specific application field, the system is applied to an integrated operation center that supervises data centers at a plurality of bases. The system is used for a continuous service improvement process of IT service management.

The user interface unit provides a screen and an operation procedure for the person in charge of operation to input the consultation content from the terminal and receive and display a response from the server. For example, a text box “Please input failure content”, a “send” button, a link for referring to a past consultation history, a shortcut to an FAQ, a copy/save/print function of response content, an immediate response function to an additional question, support for voice input and voice output, an accessibility function, an on-site photo attachment function, barcode reader linkage, on-site map display, an emergency notification button, and the like are implemented on the screen of the terminal. The user interface unit also provides input assistance and automatic completion, template selection, automatic summarization of input content, multilingual support of input content, hands-free operation during on-site work, real-time transmission of on-site photos and voice records, designation of a failure location on an on-site map, and the like according to attributes and past usage histories of the person in charge of operation. Specifically, the user interface unit acquires streaming data from a sensor group of the terminal. The user interface unit temporarily stores the acquired data in a ring buffer on a memory. The user interface unit establishes a bidirectional asynchronous communication channel with the server using WebSocket communication. The user interface unit utilizes a spatial coordinate transformation algorithm to process the designation of the failure location on the on-site map. Input data to the spatial coordinate transformation algorithm is two-dimensional screen coordinates of a position tapped by the user on the screen, and a zoom level and a scroll position of the map. The number of dimensions of the input data is, for example, a two-dimensional vector of an X coordinate and a Y coordinate. Element contents of the input data are integer values in units of pixels. The user interface unit executes scaling according to a screen resolution of a device as preprocessing. As a specific example of the input data, the first is coordinate data “X: 512, Y: 384” tapped near the center of the screen. The second is coordinate data “X: 100, Y: 100” tapped at the upper left of the screen. The third is coordinate data “X: 900, Y: 700” tapped at the lower right of the screen. The spatial coordinate transformation algorithm processes the input screen coordinates using an affine transformation matrix. The spatial coordinate transformation algorithm generates actual physical three-dimensional coordinates or a rack ID in the data center as output data. A format of the output data is a floating-point number vector in units of meters in a real space, or an identifier of a character string. Each value of the output data means a specific physical position where the failure has occurred. As a specific example of the output data, the first is position information “zone A, row 3, rack 5”. The second is position information “floor 2, air conditioner number 4”. The third is position information “power supply room, distribution board B”. The user interface unit passes the output position information to subsequent processing. The user interface unit adds the position information as metadata to the consultation content text in the subsequent processing, and transmits it to the server. The user interface unit inputs the response text received from the server to a voice synthesis engine, and executes voice reading for hands-free operation. Thereby, the system reduces a cognitive load of an on-site worker, and enables intuitive information input. The system accurately transmits a spatial context to the server, and improves accuracy of the response. The system maintains robust communication even in an environment where a network bandwidth is unstable. The system provides a flexible interface adapted to various devices and user characteristics. As a specific application field, the system is applied to a terminal of a field engineer who performs maintenance work while moving in a vast factory. The system is used for a visual work support application using augmented reality glasses.

The security control unit performs encryption of communication, access authority management, login authentication, masking/anonymization of data, authority control at the time of saving/referring to the consultation content, confidential information detection by AI, a security check at the time of external system linkage, access control of outsourcing contractors, temporary expansion of access authority in an emergency, acquisition of an audit log, unauthorized access detection, and the like in order to ensure information security of the entire system. For example, a secure protocol such as HTTPS is used for communication between the server and the terminal, manuals and consultation histories accessible for each person in charge of operation are limited, and acquisition of an audit log and unauthorized access detection by the administrator are also implemented. The security control unit is also responsible for automatic classification and risk level determination of the consultation content by AI, automatic notification to the administrator according to a degree of urgency, a security check at the time of data linkage with an outsourcing destination, temporary expansion of access authority and automatic recovery at the time of failure occurrence, and the like. Specifically, the security control unit executes stateless authentication using a JSON web token for all API requests. The security control unit drives a hybrid authorization engine combining role-based access control and attribute-based access control. The security control unit utilizes an anomaly detection neural network for unauthorized access detection. Input data to the anomaly detection neural network is a feature vector obtained by encoding a login time of the user, an IP address, an accessed resource URI, an operation type, and the like. The number of dimensions of the input data is, for example, 128 dimensions. Element contents of the input data are values obtained by one-hot encoding categorical variables and floating-point numbers obtained by normalizing continuous variables. The security control unit executes calculation of a baseline profile based on a past access history as preprocessing. As a specific example of the input data, the first is a feature vector of an access requesting administrator authority from an overseas IP in a midnight time zone. The second is a feature vector of an access downloading a large amount of manuals in a short time. The third is a feature vector of an access attempting login from a terminal different from usual. The anomaly detection neural network processes the input vector with an autoencoder architecture. The anomaly detection neural network generates a reconstruction error of the input vector as output data. A format of the output data is a single floating-point number. Each value of the output data means an anomaly score of an access pattern. As a specific example of the output data, the first is a low score “0.05” for a normal access. The second is a medium score “0.45” for a slightly suspicious access. The third is a high score “0.95” for a clear unauthorized access. The security control unit passes the output anomaly score to subsequent processing. When the score exceeds a threshold value in the subsequent processing, the security control unit forcibly disconnects the corresponding session, and transmits an alert to the administrator. When an emergency failure occurs, the security control unit issues a one-time token permitting temporary privileged access, and executes a process of automatically depriving the authority after completion of work. Thereby, the system realizes a zero trust security model that does not depend on perimeter defense. The system minimizes damage caused by an internal crime or account hijacking. The system eliminates a trade-off between security and operation efficiency, and does not hinder a rapid response in an emergency. The system provides a safe data linkage foundation with outsourcing contractors. As a specific application field, the system is applied to network management of a defense-related facility where high confidentiality is required. The system is used for access management of a large-scale system development project in which many external vendors are involved.

The external linkage unit cooperates with a monitoring system, a configuration management system, an entry/exit management system, an outsourcing contractor management system, a cloud service, an API linkage destination, and the like in the data center, and realizes automatic detection at the time of failure occurrence, automatic acquisition of a configuration change history, automatic recording of outsourcing work, automatic linkage of a monitoring alert, automatic data acquisition from an external system, automatic notification in an emergency, and the like. For example, when a storage failure alert is automatically transmitted from the monitoring system, the consultation reception unit can automatically receive failure content, and immediately execute automatic response measure presentation by AI. The external linkage unit also centrally manages entry/exit histories and work histories of outsourcing contractors, failure information of cloud services, change histories of the configuration management system, monitoring alert histories, real-time data from API linkage destinations, and the like, and utilizes them for failure cause analysis and response measure proposal by AI. Specifically, the external linkage unit adopts an event-driven architecture, and asynchronously receives data via a message broker. The external linkage unit publishes a webhook endpoint, and waits for a push notification from an external system. The external linkage unit passes the received data of various formats through a normalization pipeline. The external linkage unit utilizes a graph neural network for failure cause analysis. Input data to the graph neural network is a list of nodes and edges acquired from a configuration management database, and a current status vector of each node. The number of dimensions of the input data is the number of nodes times the number of feature dimensions, and an adjacency matrix of edges. Element contents of the input data are physical and logical connection relationships between devices such as servers, switches, and storages, and numerical values indicating CPU usage rates and alert states of respective devices. The external linkage unit executes normalization of a graph and removal of an isolated node as preprocessing. As a specific example of the input data, the first is topology data of a core switch and a group of tens of servers connected thereto. The second is dependency relationship data of a virtual machine, a physical host, and a shared storage. The third is API call route data between microservices. The graph neural network processes the input graph structure with a message passing layer. The graph neural network generates a probability that each node is a root cause of a failure as output data. A format of the output data is a probability distribution vector having the number of dimensions equal to the number of nodes. Each value of the output data means a likelihood that a specific device causes an abnormality of the entire system. As a specific example of the output data, the first is a high probability value “0.92” for a specific shared storage. The second is a probability value “0.88” for a specific network switch. The third is a probability value “0.95” for a specific database server. The external linkage unit passes the output probability distribution to subsequent processing. The external linkage unit specifies a node having the highest probability as a root cause in the subsequent processing, and extracts a configuration change history and an outsourcing work history related to the node from the database. The external linkage unit provides the extracted history information to the generative AI processing unit as a context. Thereby, the system unravels a chain of failures in a complexly intertwined system environment. The system rapidly specifies a true cause behind a superficial alert. The system cross-analyzes siloed operation data, and derives an overall optimized response measure. The system also takes in failure information of an external service, and predicts an impact on its own system. As a specific application field, the system is applied to integrated incident management in a hybrid cloud environment. The system is used for failure isolation work of an IT system constituting a complex supply chain.

As specific examples of a prompt sentence to be read by the generative AI when implementing the present invention, “Please refer to operation manuals, past failure cases, security guides, inspection records, outsourcing work histories, and monitoring alert histories for the following failure content, and generate an optimal response measure to be executed by an on-site person in charge. Failure content: ‘A storage failure has occurred’”, “Please generate a guidance text asking a person in charge for additionally required information for the following consultation content. Consultation content: ‘Network is slow’”, “When there are a plurality of related manuals, past cases, guidelines, inspection records, outsourcing work histories, and monitoring alert histories for the following failure content, please evaluate relevance and importance, and generate a prioritized response text. Failure content: ‘Backup failed’”, “Please analyze on-site photos, voice records, and on-site map information for the following consultation content, and generate a guidance text supporting automatic determination of a failure situation and grasping of an on-site situation. Consultation content: ‘Air conditioning alarm is sounding’”, and the like are cited. These prompt sentences are indispensable for the generative AI to comprehensively analyze a complex on-site situation and various history information, and automatically generate an optimal response measure and an additional question. Specifically, the system dynamically constructs a prompt template using prompt engineering technology. The system combines an input text of the user, a searched context document, and a role definition of the system. The system inputs the constructed prompt to a large language model. Input data to the large language model is a one-dimensional array of integers obtained by tokenizing a text with a byte pair encoding algorithm. The number of dimensions of the input data depends on a context window size of the model, and is, for example, a maximum of 4096 dimensions. Element contents of the input data are vocabulary indices corresponding to respective subwords. The system replaces a placeholder in the prompt with a variable value and inserts a special token as preprocessing. As a specific example of the input data, the first is a token array including a system role, a task instruction, and a context of a storage failure. The second is a token array including the consultation content of the network delay and a past similar case as an example of few-shot learning. The third is a token array including the consultation content of the air conditioning alarm and a text description output by an image recognition model. The large language model processes the input array with a multi-layer transformer block. The large language model generates a token sequence of the generated text as output data. A format of the output data is a one-dimensional array of vocabulary indices. Each value of the output data means a word or a symbol autoregressively predicted by the model. As a specific example of the output data, the first is a token array corresponding to a text “First, please confirm a power supply of the storage”. The second is a token array corresponding to a text “In which segment is the delay occurring?”. The third is a token array corresponding to a text “Please confirm a water level of a drain pan of the air conditioner”. The system passes the output token array to subsequent processing. The system inversely converts the token array into a human-readable character string using a decoder in the subsequent processing. The system executes filtering of inappropriate terms and formatting of a format for the generated character string. Thereby, the system optimizes an inference capability of the large language model to a specific business domain. The system guarantees that the model accurately understands a context and outputs a response in an expected format. The system significantly reduces a risk of hallucination by structuring the prompt. The system draws out an ability to divide a complex inference task into a plurality of steps and process them. As a specific application field, the system is applied to an automatic response engine of technical support requiring specialized knowledge. The system is used for an advisory system of a business process based on internal regulations and compliance.

### Implementation Steps

Step 1: Input and Reception of On-site Consultation Content A person in charge of operation or an engineer inputs a consultation content regarding failure occurrence, an operation procedure, a security incident, daily inspection, configuration change, outsourcing management, and the like using a user interface such as a personal computer, a tablet, a smartphone, or a dedicated terminal. Input methods are diverse, such as text input, voice input, on-site photo attachment, device ID input by a barcode reader, and designation of a failure location on an on-site map, and the consultation reception unit receives and records these pieces of information together with metadata such as a time, user identification information, terminal information, a failure type, an impact range, an on-site photo, a voice record, and on-site map information. For example, it responds to various on-site situations such as “A storage failure has occurred. I want you to tell me a response procedure”, “An air conditioning alarm is sounding”, and “An outsourcing contractor has entered the building, but a work procedure is unknown”. Specifically, the consultation reception unit detects a hardware interrupt from an input device, and activates a data reception thread. The consultation reception unit processes simultaneous connections from a plurality of terminals by multi-thread processing. The consultation reception unit serializes the received multimodal data, and stores it in a queue on a memory. The consultation reception unit utilizes a data verification algorithm to evaluate quality of the input data. Input data to the data verification algorithm is a feature vector including the number of characters of the received text, a sampling rate of an audio file, a resolution of an image, and the like. The number of dimensions of the input data is, for example, 10 dimensions. Element contents of the input data are numerical values indicating metadata of respective media formats. The consultation reception unit analyzes header information of the data and confirms consistency of a format as preprocessing. As a specific example of the input data, the first is text metadata having 50 characters and a language code of Japanese. The second is audio metadata having a sampling rate of 16 kHz and a bit depth of 16 bits. The third is image metadata having a resolution of 1920 times 1080 and a JPEG format. The data verification algorithm processes the input vector with a rule-based determiner. The data verification algorithm generates a Boolean value indicating validity of the data and an error code as output data. A format of the output data is a truth value and an integer code. Each value of the output data means whether the data satisfies quality capable of withstanding subsequent AI processing. As a specific example of the output data, the first is validity “true” and an error code “0”. The second is validity “false” and an error code “101 (excessive audio noise)”. The third is validity “false” and an error code “202 (unclear image)”. The consultation reception unit passes the output Boolean value to subsequent processing. The consultation reception unit writes the data to a persistent storage when the validity is “true” in the subsequent processing. The consultation reception unit transmits an error message prompting the user for re-input when the validity is “false”. Thereby, the system prevents data loss even at the time of high load, and ensures real-time performance. The system prevents defective data from being mixed into a subsequent inference pipeline. The system integrates various input interfaces, and captures an on-site situation without omission. The system improves robustness and reliability of the entire system. As a specific application field, the system is applied to a multi-channel information collection system in a disaster response base. The system is used for a monitoring platform that integrates reports from IoT sensors and workers in a factory.

### Step 2: Automatic Classification and Preprocessing of Consultation Content

The consultation reception unit automatically performs category classification, content summarization, and main keyword extraction on the received consultation content using generative AI. For example, keywords such as “storage failure”, “failure response”, “disconnection”, and “spare storage” are extracted, and a failure type, an impact range, related device information, and the like are automatically organized. As a specific example of a prompt sentence to be read by the generative AI, “Classify the following consultation content into a failure type, an impact range, a related device, and a work category, and extract a summary and main keywords. Consultation content: ‘A storage failure has occurred. Please tell me a response procedure.’” is given. Specifically, the consultation reception unit activates a natural language processing pipeline. The consultation reception unit inputs text data to a tokenizer and divides it into words and subwords. The consultation reception unit executes stop word removal and stemming to normalize the text. The consultation reception unit inputs the normalized text to a pre-trained language model. Input data to the language model is a one-dimensional array of token IDs. The number of dimensions of the input data is a maximum of 512 dimensions. Element contents of the input data are integer values based on a vocabulary dictionary. The consultation reception unit executes padding and truncation as preprocessing to fix a length of the array. As specific examples of the input data, a first one is an ID array of a token sequence “storage, failure, occurrence, response, procedure”. A second one is an ID array of a token sequence “network, delay, cause, investigation”. A third one is an ID array of a token sequence “server, restart, failure”. The language model processes the input array with a transformer encoder. The language model generates a feature vector expressing a context of the text and a probability distribution belonging to each category as output data. A format of the output data is, for example, a 768-dimensional dense vector and a probability vector having dimensions equal to the number of categories. Each value of the output data means a semantic representation of the text and a certainty factor of classification. As specific examples of the output data, a first one is a probability “0.95” for a hardware failure category. A second one is a probability “0.88” for a network failure category. A third one is a probability “0.92” for a software failure category. The consultation reception unit passes the output feature vector and probability distribution to subsequent processing. The consultation reception unit adopts a category having a maximum probability as a classification result in the subsequent processing. The consultation reception unit executes a keyword extraction algorithm using the feature vector, and extracts a word having a large attention weight as a main keyword. Thereby, the system converts unstructured text into structured data, enabling mechanical processing. The system removes noise and dramatically improves efficiency and accuracy of subsequent search processing. The system completely automates manual tagging work by humans. The system organizes and classifies a large amount of consultation data in real time. As specific application fields, the system is applied to an automatic triage system for a large amount of inquiry emails sent to customer support. The system is used for a monitoring system that analyzes failure report tweets on SNS in real time.

### Step 3: Search and Extraction of Related Information

The information reference unit searches for and extracts related information at high speed from operation manuals, failure response procedure manuals, security guidelines, access authority management regulations, backup/restore procedure manuals, outsourcing operation regulations, configuration change application procedures, power supply/air conditioning/fire alarm response procedures, a past failure response case database, inspection records, outsourcing work reports, monitoring alert histories, an on-site photo database, and the like based on the extracted keywords and category information. For example, “storage failure response procedure”, “past storage failure cases”, “latest inspection records”, “outsourcing work history”, “monitoring alert history”, and the like are cross-sectionally extracted. Specifically, the information reference unit drives a hybrid search engine of a keyword search using an inverted index and a semantic search using a vector index. The information reference unit queries the inverted index using the extracted keywords as a query, and calculates a score of a document using a BM25 algorithm. The information reference unit inputs the text of the consultation content to an embedding model, and generates a query vector. Input data to the embedding model is a text character string of the consultation content. The number of dimensions of the input data depends on a length of the character string. Element contents of the input data are an array of character codes. The information reference unit executes text normalization as preprocessing. As specific examples of the input data, a first one is a text “a red lamp of a storage is blinking”. A second one is a text “a connection to a database times out”. A third one is a text “an abnormal noise is heard from an air conditioner”. The embedding model processes the input text and generates a high-dimensional dense vector as output data. A format of the output data is, for example, a 1024-dimensional floating-point number vector. Each value of the output data expresses a semantic feature of the text as coordinates in a multidimensional space. As specific examples of the output data, a first one is a vector located in a conceptual space of a hardware abnormality. A second one is a vector located in a conceptual space of a network communication error. A third one is a vector located in a conceptual space of a physical environment abnormality. The information reference unit passes the output query vector to subsequent processing. The information reference unit executes an approximate nearest neighbor search on a vector database in the subsequent processing, and extracts a document having a high cosine similarity. The information reference unit integrates a score of the keyword search and a score of the vector search using a reciprocal rank fusion algorithm. The information reference unit extracts top documents as a final search result based on the integrated score. Thereby, the system realizes a flexible search that does not depend on an exact match of keywords. The system maintains both a recall rate and a precision rate at a high level. The system instantly identifies information directly linked to problem solving from a huge group of internal documents. The system prevents a delay in response due to a search omission. As specific application fields, the system is applied to a cross-search system for past precedents and contracts in a law firm. The system is used for an integrated search platform for electronic medical records and medical papers in a medical institution.

### Step 4: Generation of Optimal Response Text

The generative AI processing unit receives the extracted manuals, past cases, guidelines, inspection records, outsourcing work reports, monitoring alert histories, and the consultation content of the user as inputs, and generates a response text including an optimal countermeasure, procedure, and additional confirmation items to be executed by an on-site person in charge using a natural language processing model. For example, a response conforming to on-site practice is automatically generated, such as “When a storage failure occurs, first disconnect the corresponding storage and perform switching to a spare storage. After switching, confirm consistency of backup data, and execute a recovery procedure as necessary. According to the latest inspection records, since firmware update work has been executed on the same storage within the past one month, confirmation of a firmware version is also recommended.” As a specific example of a prompt sentence to be read by the generative AI, “Generate an optimal countermeasure to be executed by an on-site person in charge for the following failure content by referring to operation manuals, past failure cases, security guides, inspection records, outsourcing work histories, and monitoring alert histories. Failure content: ‘A storage failure has occurred.’” is given. Specifically, the generative AI processing unit activates a decoder module of a retrieval-augmented generation architecture. The generative AI processing unit combines a plurality of searched document texts and the consultation content of the user to construct a prompt context. The generative AI processing unit inputs the constructed context to a large language model. Input data to the large language model is a one-dimensional array of integers obtained by tokenizing the context. The number of dimensions of the input data is a maximum of 8192 dimensions. Element contents of the input data are token IDs based on a vocabulary dictionary. The generative AI processing unit executes truncation processing for keeping a length of the context within a limit of the model as preprocessing. As specific examples of the input data, a first one is a token array combining consultation content of a storage failure and a response procedure manual. A second one is a token array combining consultation content of a network delay and past resolution cases. A third one is a token array combining consultation content of a backup failure and an error code list. The large language model processes the input array using a self-attention mechanism. The large language model generates a probability distribution of a token to be generated next step by step as output data. A format of the output data is a sequence of probability vectors having the number of dimensions equal to a vocabulary size. Each value of the output data means a likelihood that a specific word will appear next. As specific examples of the output data, a first one is a probability “0.85” of a word “first”. A second one is a probability “0.90” of a word “corresponding”. A third one is a probability “0.95” of a word “storage”. The generative AI processing unit passes the output probability distribution to subsequent processing. The generative AI processing unit searches for an optimal token sequence using a beam search algorithm in the subsequent processing. The generative AI processing unit decodes the searched token sequence into a character string, and generates a final response text. Thereby, the system suppresses hallucination not based on facts, and generates an accurate and highly reliable response. The system logically integrates a plurality of information sources and presents a consistent procedure. The system derives a dynamic countermeasure reflecting the latest regulations and histories. The system dramatically improves a self-resolution rate of the on-site person in charge. As specific application fields, the system is applied to an intelligent assistant that supports complex troubleshooting. The system is used for a response suggestion system for operators in a call center.

### Step 5: Additional Information Request and Interactive Response

When the consultation content has ambiguity or missing information, the generative AI processing unit automatically determines that point, and generates a guidance text prompting a person in charge of operation for additionally required information. For example, additional questions such as “Please tell me a model number and a connection method of the storage where the failure occurred”, “Please specifically input a failure occurrence time and an impact range”, and “Please attach an on-site photo at the time of failure occurrence” are automatically generated. When the person in charge of operation inputs additional information, a loop process of cooperating with the information reference unit again and generating an optimal response text is realized. As a specific example of a prompt sentence to be read by the generative AI, “Generate a guidance text asking the person in charge for additionally required information for the following consultation content. Consultation content: ‘The network is slow.’” is given. Specifically, the generative AI processing unit executes a slot filling task using a dialogue state tracking model. Input data to the dialogue state tracking model is an embedding vector of a token sequence combining a dialogue history up to now and a current user input text. The number of dimensions of the input data is, for example, 768 dimensions. Element contents of the input data are floating-point numbers expressing semantic features of the text. The generative AI processing unit executes summarization of the dialogue history and filtering of unnecessary utterances as preprocessing. As specific examples of the input data, a first one is a vector representation of an initial input “The network is slow”. A second one is a vector representation combining a system utterance “Which segment is it?” and a user response “It is a floor of a sales department”. A third one is a vector representation combining a system utterance “Is an error message displayed?” and a user response “It is displayed as timeout”. The dialogue state tracking model processes the input vector with a transformer encoder. The dialogue state tracking model generates a satisfaction state of each information slot and an extracted value as output data. A format of the output data is dictionary structure data having a slot name as a key and a satisfaction flag and an extracted value as values. Each value of the output data means whether specific information necessary for problem solving has already been provided. As specific examples of the output data, a first one is a satisfaction flag “false” of a “device model number” slot. A second one is a satisfaction flag “true” and an extracted value “14:30” of an “occurrence time” slot. A third one is a satisfaction flag “false” of an “impact range” slot. The generative AI processing unit passes the output dictionary structure data to subsequent processing. The generative AI processing unit identifies an essential slot whose satisfaction flag is “false” in the subsequent processing. The generative AI processing unit generates a question sentence for filling the identified slot using a language model. Thereby, the system efficiently collects information while maintaining a context of a dialogue. The system complements an ambiguous input of the user and prepares conditions necessary for accurate inference. The system realizes an interactive interface that naturally interacts with a human. The system automates problem isolation work and shortens a time until resolution. As specific application fields, the system is applied to an automated chatbot for primary response in an IT help desk. The system is used for a symptom hearing system from a patient in a medical interview.

### Step 6: Presentation of Response Content and History Management

The generated optimal response text is presented to a terminal of the person in charge of operation via the user interface unit. The person in charge of operation can confirm the response content and perform an additional question or re-consultation as necessary. All consultation contents, response contents, additional questions, input histories, manual reference histories, detailed logs of a response generation process by AI, on-site photos and voice records, outsourcing work histories, inspection records, monitoring alert histories, and the like are recorded in chronological order by the log management unit. An administrator can search, aggregate, and analyze these histories, and utilize them for grasping failure trends, automatically generating FAQs, revising manuals, managing safety of on-site work, strictly enforcing outsourcing management, and the like. Specifically, the user interface unit renders the generated text data in a markdown format and draws it on a screen of the terminal. The user interface unit receives a feedback input from the user. The log management unit asynchronously writes a series of transaction data to a database. The log management unit processes the accumulated log data as a dataset for a reward model for reinforcement learning. Input data to the reward model is a feature vector combining the consultation content of the user, the response text generated by the system, and an evaluation score from the user. The number of dimensions of the input data is, for example, 1024 dimensions. Element contents of the input data are an embedding vector of text and a numerical value of the evaluation score. The log management unit executes text normalization and evaluation score standardization as preprocessing. As specific examples of the input data, a first one is a vector combining a consultation of a storage failure, an accurate response, and a score of “high evaluation”. A second one is a vector combining a consultation of a network delay, an insufficient response, and a score of “low evaluation”. A third one is a vector combining a consultation of a password reset, an accurate procedure, and a score of “high evaluation”. The reward model processes the input vector with a multilayer perceptron. The reward model generates a predicted reward value indicating quality of a system response as output data. A format of the output data is a single floating-point number. Each value of the output data means how much the generated response matches human expectations. As specific examples of the output data, a first one is a high reward value of “0.95” for an excellent response. A second one is a low reward value of “−0.5” for an inappropriate response. A third one is a reward value of “0.2” for an average response. The log management unit passes the output predicted reward value to subsequent processing. The log management unit fine-tunes parameters of the large language model by a proximal policy optimization algorithm using this reward value in the subsequent processing. Thereby, the system continuously improves a user experience. The system accumulates tacit knowledge of an operation site as explicit knowledge in the system. The system constructs a self-evolving AI infrastructure incorporating human feedback. The system permanently enhances quality of data center operation. As specific application fields, the system is applied to analysis of automatic test results in a continuous integration and continuous delivery pipeline. The system is used for an automatic evaluation system of response quality in a large-scale customer success department.

### Step 7: Operation, Analysis, and Improvement by Administrator

Using the administrator interface unit, a system administrator or a data center operation manager performs updating of manuals and a past case database, tuning of an AI model, analysis of failure trends, monitoring of a usage status, access authority management, management of outsourcing work histories, reference to inspection records, emergency notification at the time of failure occurrence, automatic generation of FAQs, quality evaluation of AI response contents, blacklisting of specific consultation contents, access control for each person in charge of operation, management of monitoring alert histories, management of on-site photos and voice records, and the like. The administrator utilizes statistical analysis of consultation contents and response contents, dashboard display, graphing of failure trends, feedback input for improving AI response accuracy, automatic determination of a risk level of consultation contents, an escalation function according to an urgency level, contact history management with an outsourcing contractor, automatic aggregation of inspection records, automatic analysis of monitoring alert histories, automatic classification of on-site photos and voice records, and the like, to improve operation efficiency and on-site response capability of the entire system. Specifically, the system analyzes operation data input via the administrator interface unit. The processing unit executes statistical analysis and extraction of failure trends using a large language model. Thereby, the operation efficiency and the on-site response capability of the entire system are improved.

### Specific Use Case

For example, assume a situation where a person in charge of data center operation receives a failure alert of a storage device from a monitoring system late at night and rushes to a site. This person in charge uses the user interface unit of an on-site terminal to voice-input “A storage failure has occurred. Please tell me a response procedure.”, reads a model number of the failed storage with a barcode reader, attaches an on-site photo, and sends them to the consultation reception unit. The consultation reception unit automatically records metadata such as failure content, a time, a person-in-charge ID, an on-site photo, a device ID, a failure occurrence time, and an impact range, and extracts keywords such as “storage failure”, “failure response”, “disconnection”, and “spare storage” by automatic classification using generative AI. The information reference unit cross-sectionally extracts a failure response procedure related to the corresponding storage model number, a failure case that occurred in the past with the same model number, a latest firmware update history, a work history by an outsourcing contractor, a monitoring alert history in the same time zone, and the like from operation manuals, failure response procedure manuals, past failure cases, inspection records, outsourcing work histories, and monitoring alert histories. Specifically, the system receives voice data and image data from the on-site terminal. The processing unit analyzes these input data using a neural network, and extracts a related failure response procedure and past cases. Thereby, a prompt and accurate failure response becomes possible.

Based on these pieces of information, the generative AI processing unit automatically generates a response text conforming to on-site practice, such as “When a storage failure occurs, first disconnect the corresponding storage and perform switching to a spare storage. After switching, confirm consistency of backup data, and execute a recovery procedure as necessary. According to the latest inspection records, since firmware update work has been executed on the same storage within the past one month, confirmation of a firmware version is also recommended. Based on the outsourcing work history, additionally execute inspection items after work. Based on the monitoring alert history, confirm presence or absence of other alerts in the same time zone.”, and presents it to the person in charge via the user interface unit. When the person in charge inputs additional information “The model number of the failed storage is XX, the connection method is SAS, the failure occurrence time is 2:15, and the number of affected servers is 3”, the generative AI searches for related information again, and presents a more precise countermeasure and additional confirmation items. All exchanges, on-site photos, voice records, and reference histories are recorded in chronological order by the log management unit, and the administrator can utilize them for failure trend analysis, automatic generation of FAQs, manual revision, safety management of on-site work, strict enforcement of outsourcing management, and the like. Specifically, the generation processing unit inputs the extracted related information to a large language model, and generates a response text conforming to on-site practice. The system presents the generated response to the person in charge via the user interface unit. Thereby, safety and efficiency of on-site work are improved.

Also, for example, when an abnormality alarm of an air conditioning facility occurs, the person in charge inputs “An air conditioning alarm is sounding. Please tell me a response method.”, attaches an on-site photo and recorded data of an alarm sound, and sends them. The generative AI presents a specific countermeasure such as “At the time of an air conditioning abnormality, first confirm a temperature and humidity at the site, and in the case of an abnormal value, inspect presence or absence of filter clogging or refrigerant leakage of the air conditioning facility. Refer to the latest inspection records and outsourcing work histories, and execute emergency contact to an external contractor as necessary.” Furthermore, when a network delay occurs, an additional question such as “Please tell me a network section where the delay is occurring and an IP address of an affected server” or “Please tell me presence or absence of a recent configuration change or outsourcing work” is automatically generated, and an optimal countermeasure referring to a network failure response procedure, past similar cases, and monitoring alert histories is presented based on additional information from the person in charge. Specifically, the system receives input data regarding an air conditioning abnormality or a network delay. The processing unit analyzes a situation using a natural language processing model, and generates a specific countermeasure and an additional question. Thereby, a flexible response to various failures is realized.

In such a use case, specific examples of a prompt text to be read by the generative AI include: ‘Please refer to operation manuals, past failure cases, security guides, inspection records, outsourcing work histories, and monitoring alert histories for the following failure content, and generate an optimal countermeasure to be executed by an on-site person in charge. Failure content: “A storage failure has occurred”’, ‘Please generate a guidance text asking a person in charge for additionally required information for the following consultation content. Consultation content: “The network is slow”’, ‘When there are a plurality of related manuals, past cases, guidelines, inspection records, outsourcing work histories, and monitoring alert histories for the following failure content, please evaluate relevance and importance, and generate a prioritized response text. Failure content: “A backup has failed”’, and ‘Please analyze on-site photographs, voice records, and on-site map information for the following consultation content, and generate a guidance text supporting automatic determination of a failure situation and grasping of an on-site situation. Consultation content: “An air conditioning alarm is sounding”’. Specifically, the present system configures input data to a large language model using a specific prompt template. The present processing unit incorporates the failure content and related information into the prompt, and causes an optimal countermeasure and an additional question to be generated. Thereby, output accuracy and relevance of the model are improved.

In this way, the system of the present invention can dramatically improve failure response capability, operational efficiency, safety, and knowledge utilization capability of a data center operation site by the generative AI comprehensively analyzing various information such as an on-site history, a manual, a past case, an inspection record, an outsourcing history, and a monitoring alert in response to a failure or an operation consultation input by an on-site person in charge, and automatically generating an optimal countermeasure and an additional question conforming to an on-site situation. Specifically, the present system integrally analyzes various on-site information. The present processing unit automatically generates an optimal countermeasure using a machine learning model. Thereby, the operational efficiency and the knowledge utilization capability of the data center operation site are dramatically improved.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

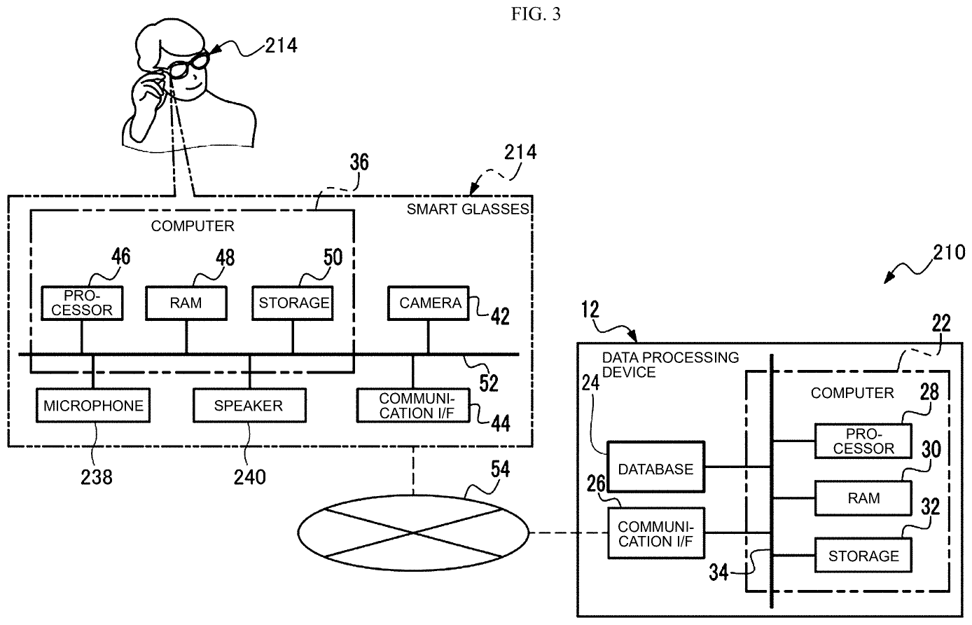

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

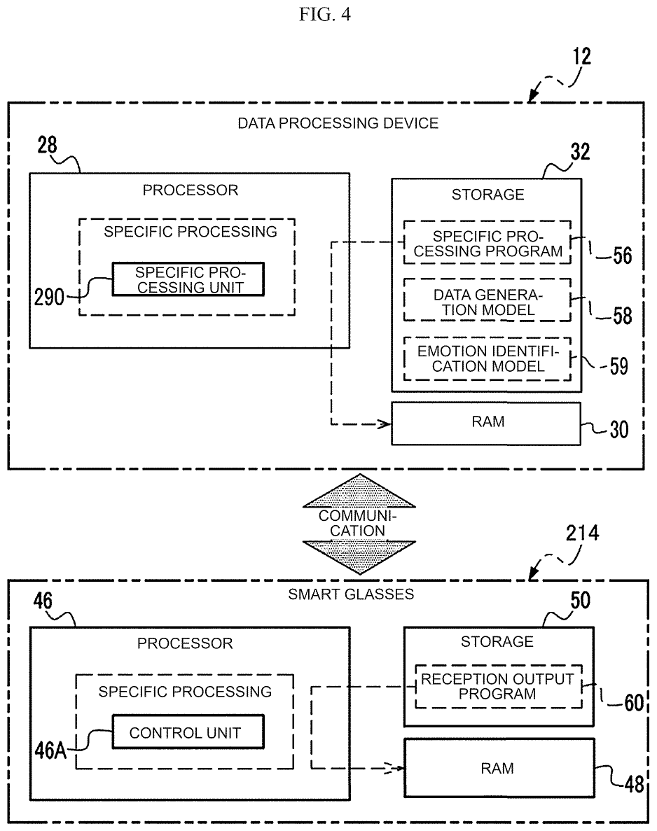

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

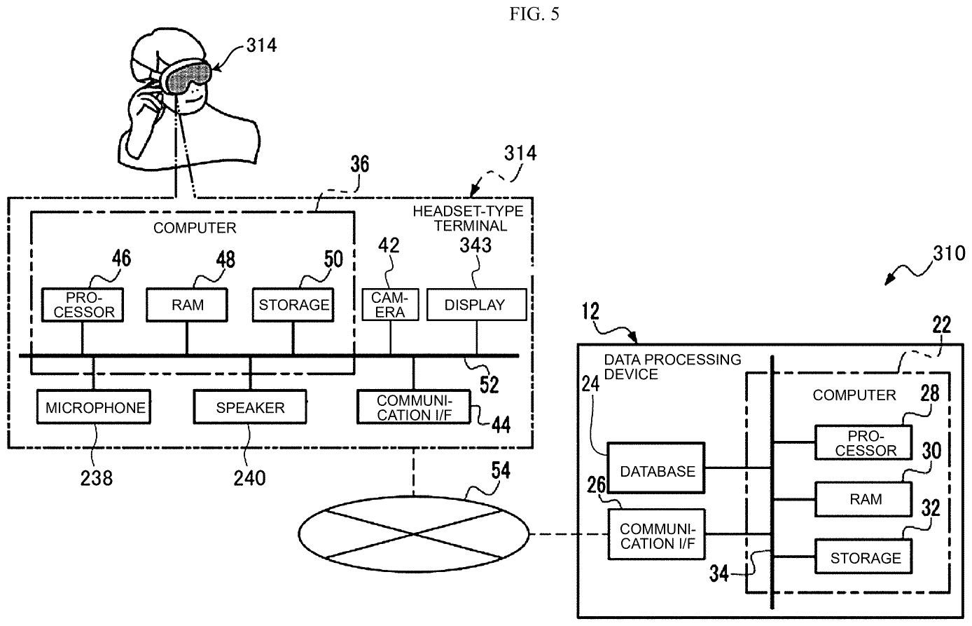

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

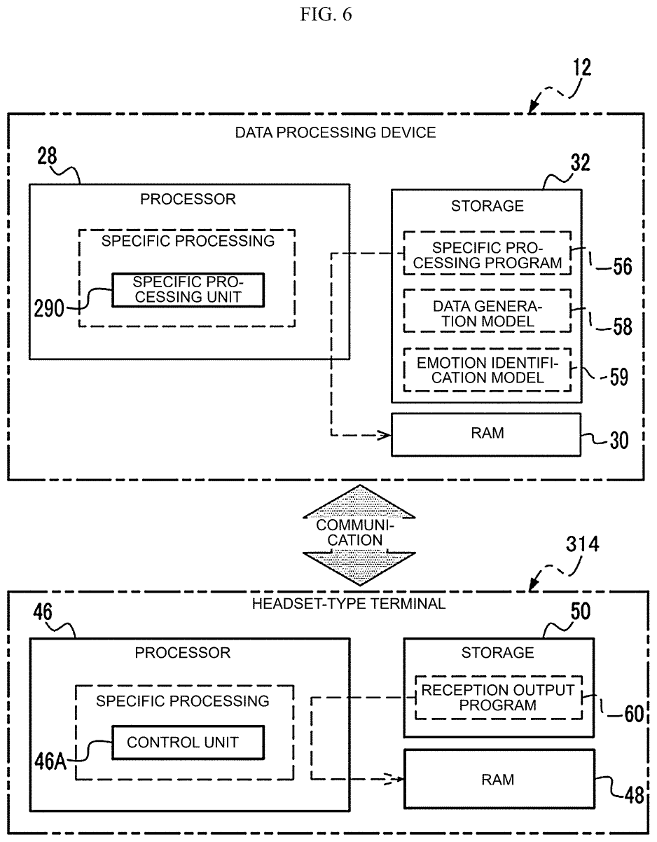

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

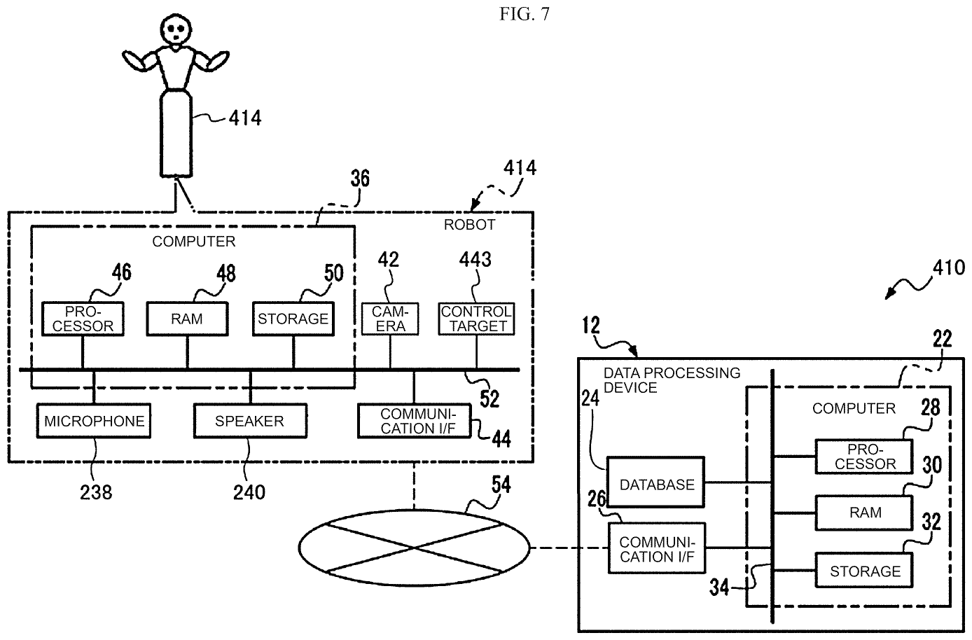

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

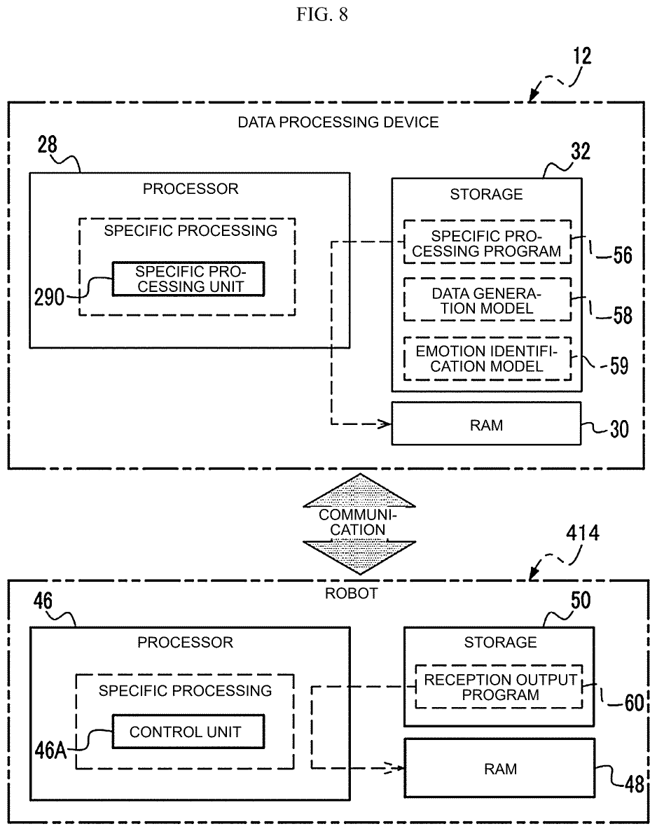

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

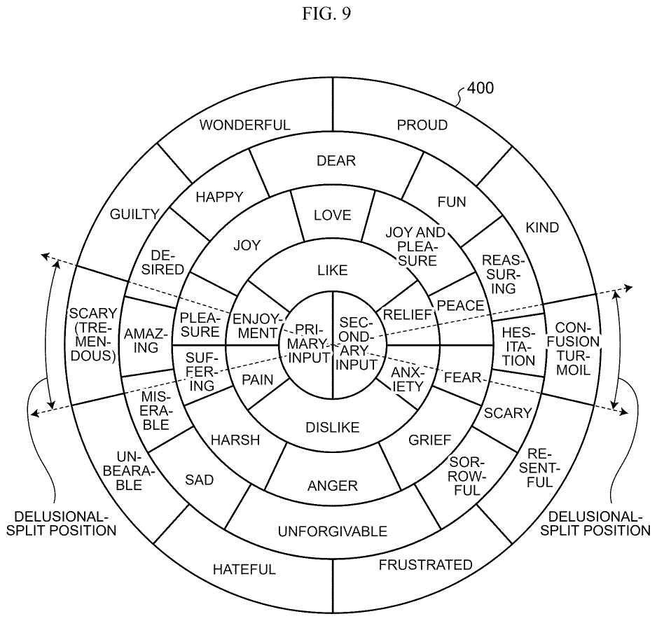

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

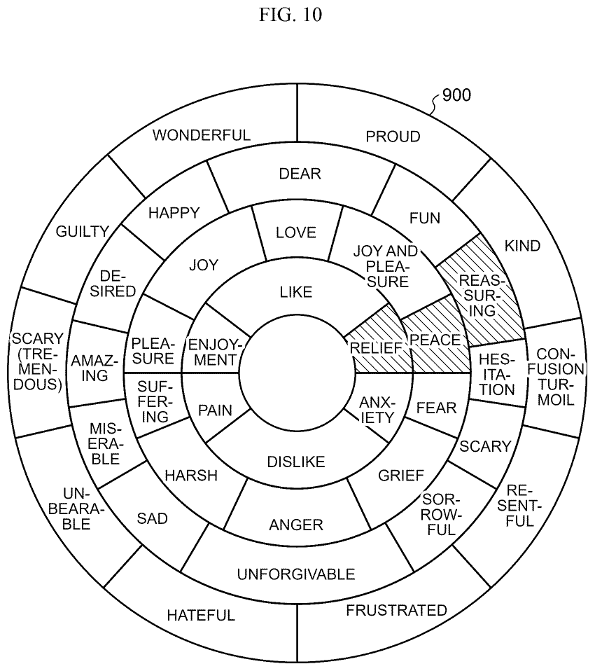

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A system for automating operation support of a data center, the system comprising a consultation reception unit, an information reference unit, and a generative AI processing unit, wherein the consultation reception unit is configured to receive a consultation content at a time of failure occurrence, at a time of operation, or at a time of security incident occurrence input from a person in charge of data center operation or an engineer, and record the received consultation content together with metadata such as a time, user identification information, a failure type, and an impact range; the information reference unit is configured to hold operation manuals, failure response procedure manuals, security guidelines, a past failure response case database, and the like in a storage device, and search for corresponding manuals, cases, and guidelines based on keywords and context information included in the consultation content received from the consultation reception unit; the generative AI processing unit is configured to perform natural language processing using the consultation content and the searched manuals, cases, and guidelines as inputs, generate an optimal response text including countermeasures, procedures, and additional confirmation items for the failure or the incident, and present the response text to a user via the consultation reception unit; and the generative AI processing unit is further configured to automatically determine ambiguity or missing information in the consultation content using generative AI, and generate a guidance text prompting input of additional information as necessary.

### Supplementary Note 2

The system according to Supplementary Note 1, wherein, when a plurality of related manuals, a plurality of past failure cases, or a plurality of security guidelines are extracted for the consultation content, the generative AI processing unit is configured to automatically evaluate importance and relevance of each manual, case, and guideline, generate a response text including information prioritized based on an evaluation result, and present the response text to the user.

### Supplementary Note 3

The system according to Supplementary Note 1, wherein, when a corresponding manual, failure case, or guideline does not exist for the consultation content, the generative AI processing unit is configured to perform content analysis of the consultation content, automatically generate and present additionally required information and questions to the user, and repeatedly execute searching for a manual, a case, and a guideline and generating the response text again upon receiving an additional information input from the user.

What is claimed is:

1. A system comprising:
circuitry configured to:
receive, via a communication interface coupled to a packet-switched network, query data from a terminal device, the query data comprising text data and optionally audio data, and store the query data in a storage device;
process audio data in the query data by applying a voice recognition model to convert audio waveform data into query text, and tokenize the query text using a natural language processing model to generate a query embedding vector;
retrieve reference records from a vector database storing reference document records and historical query records by computing cosine similarity scores between the query embedding vector and stored reference record embedding vectors, and select reference records having cosine similarity scores exceeding a retrieval threshold parameter;
apply a generative neural network model to the query embedding vector and the selected reference records to generate response text data, and detect ambiguity or missing information in the query data by applying an ambiguity classification model to the query embedding vector; and
transmit the response text data to the terminal device via the communication interface, or transmit a clarification prompt data record to the terminal device requesting additional information when ambiguity or missing information is detected.

2. The system according to claim 1, wherein the circuitry is configured to receive analog audio signal data from a microphone device at the terminal device, apply an analog-to-digital converter to produce digital audio data in a pulse code modulation format, and apply the voice recognition model to the digital audio data to generate query text, the voice recognition model comprising a transformer-based acoustic model with a self-attention mechanism.

3. The system according to claim 2, wherein the circuitry is configured to apply noise cancellation processing to the digital audio data prior to input to the voice recognition model, and generate an audio confidence score for each decoded text segment, and flag audio segments having confidence scores below an audio confidence threshold for user review prior to query processing.

4. The system according to claim 1, wherein the circuitry is configured to receive image data from a camera device at the terminal device via the communication interface, apply an optical character recognition model to the image data to extract text content, and incorporate the extracted text content as additional query data fields in the query embedding vector generation pipeline.

5. The system according to claim 1, wherein the circuitry is configured to apply a multi-stage retrieval process by first computing cosine similarity scores between the query embedding vector and reference document section-level embedding vectors indexed in the vector database, and then reranking retrieved reference document sections by a cross-encoder relevance model to generate a refined set of reference records for input to the generative neural network model.

6. The system according to claim 5, wherein the circuitry is configured to evaluate importance and relevance scores for each retrieved reference record using the cross-encoder relevance model, sort the retrieved reference records in descending order of relevance score, and incorporate the top-ranked reference records weighted by relevance score into a retrieval-augmented generation prompt.

7. The system according to claim 1, wherein the circuitry is configured to apply the ambiguity classification model to the query embedding vector to generate an ambiguity score, compare the ambiguity score against an ambiguity threshold parameter, and when the ambiguity score exceeds the ambiguity threshold parameter, generate the clarification prompt data record comprising a plurality of targeted question items derived from the ambiguity classification model output.

8. The system according to claim 7, wherein the circuitry is configured to receive supplemental query data from the terminal device in response to the clarification prompt data record, generate an updated query embedding vector incorporating the supplemental query data, and re-execute the retrieval and response generation pipeline using the updated query embedding vector.

9. The system according to claim 1, wherein the circuitry is configured to store the query data, the query embedding vector, the selected reference records, and the response text data as a query session record in the storage device, index the query session record in the vector database for future retrieval, and compute a user satisfaction update based on feedback data received from the terminal device following response transmission.

10. The system according to claim 9, wherein the circuitry is configured to periodically apply a clustering algorithm to stored query session records to identify recurring query pattern clusters, generate cluster centroid embedding vectors representing each cluster, and incorporate the cluster centroid embedding vectors as enhanced index entries in the vector database to improve future retrieval precision.

11. The system according to claim 1, wherein the circuitry is configured to receive barcode scan data from a barcode reader device at the terminal device via the communication interface, decode the barcode scan data to extract an equipment identifier, retrieve equipment-specific reference records associated with the equipment identifier from the storage device, and incorporate the retrieved equipment-specific reference records as additional context in the retrieval-augmented generation prompt.

12. The system according to claim 1, wherein the circuitry is configured to apply a log management operation to store all query data records, response text data records, and clarification prompt data records with timestamps and user identifiers in an audit log data structure in the storage device, and generate a query trend report from the audit log data structure for transmission to terminal devices associated with administrative user identifiers.

13. The system according to claim 1, wherein the circuitry is configured to update the vector database by applying the natural language processing model to new reference document records received via the communication interface, generating new reference document embedding vectors, and indexing the new reference document embedding vectors in the vector database using approximate nearest neighbor indexing.

14. The system according to claim 13, wherein the circuitry is configured to detect semantic similarity between new reference document embedding vectors and existing reference document embedding vectors using cosine similarity scoring, generate a deduplication flag when a similarity score exceeds a deduplication threshold, and prompt an administrator terminal device for manual review before adding a flagged reference document record to the vector database.

15. The system according to claim 1, wherein the circuitry is configured to enforce a role-based access control policy by comparing a user role parameter associated with an incoming query session against an access permission parameter associated with each reference record category, and exclude reference records in restricted categories from the retrieval set for query sessions associated with user role parameters below a required authorization level.

16. The system according to claim 1, wherein the circuitry is configured to update the generative neural network model by generating training pairs from historical query session records comprising query embedding vectors and corresponding validated response text data, and fine-tune the generative neural network model on the training pairs to improve response relevance scores for domain-specific query patterns.

17. The system according to claim 1, wherein the query data relates to technical operation procedures and incident response scenarios, and the reference document records stored in the vector database comprise operational procedure documentation, regulatory guideline records, and historical incident resolution records.

18. A system comprising:
circuitry configured to:
receive, via a communication interface coupled to a packet-switched network, query data comprising text data and audio waveform data from a terminal device;
apply a voice recognition model to the audio waveform data to generate query text, and apply a natural language processing model to generate a query embedding vector from the query text;
apply a multi-stage retrieval process to select reference records from a vector database by cosine similarity scoring followed by cross-encoder reranking, and apply a generative neural network model to the query embedding vector and selected reference records to generate response text data;
detect ambiguity in the query data using an ambiguity classification model and generate a clarification prompt data record when an ambiguity score exceeds an ambiguity threshold; and
transmit the response text data or the clarification prompt data record to the terminal device via the communication interface.

19. The system according to claim 18, wherein the circuitry is configured to store query data, query embedding vectors, selected reference records, and response text data as query session records in the storage device, apply a clustering algorithm periodically to identify recurring query pattern clusters, and incorporate cluster centroid embedding vectors as enhanced index entries in the vector database to improve future retrieval precision.

20. A method comprising:
receiving, via a communication interface coupled to a packet-switched network, query data from a terminal device, the query data comprising text data and optionally audio data, and storing the query data in a storage device;
processing audio data in the query data by applying a voice recognition model to convert audio waveform data into query text, and tokenizing the query text using a natural language processing model to generate a query embedding vector;
retrieving reference records from a vector database by computing cosine similarity scores between the query embedding vector and stored reference record embedding vectors, and selecting reference records having cosine similarity scores exceeding a retrieval threshold parameter;
applying a generative neural network model to the query embedding vector and the selected reference records to generate response text data, and detecting ambiguity or missing information in the query data by applying an ambiguity classification model to the query embedding vector; and
transmitting the response text data to the terminal device via the communication interface, or transmitting a clarification prompt data record to the terminal device requesting additional information when ambiguity or missing information is detected.
